(19) United States
(12) Patent Application Publication
(10) Pub. No.: US 2015/0127380 A1
(43) Pub. Date: May 7, 2015

(54) SYSTEMS AND METHODS OF INCREASING MEDICATION ADHERENCE

(71) Applicant: Douglas L. Aaron, New York, NY (US)

(72) Inventor: Douglas L. Aaron, New York, NY (US)

(21) Appl. No.: 14/530,608

(22) Filed: Oct. 31, 2014

Related U.S. Application Data
(60) Provisional application No. 61/899,016, filed on Nov. 1, 2013.

(51) Int. Cl. G06F 19/00; H04L 29/08

(52) U.S. Cl. CPC G06F 19/3456; H04L 67/10
USPC 705/3

(57) ABSTRACT

According to at least one embodiment, a computer system is provided. The computer system includes a memory, at least one processor coupled to the memory, and a medication management component executable by the at least one processor. The medication management component is configured to transmit a first notification to a first remote computer system, the first notification including a first request that the first remote computer system present a reminder to a patient, the reminder requesting that the patient adhere to a medication regimen; receive a response to the notification, the response indicating whether the patient adhered to the medication regimen; and transmit a second notification to a second remote computer system distinct from the first remote computer system, the second notification including a second request that the second remote computer system present an indication of whether the patient adhered to the medication regimen to a health care provider.

### RELATED APPLICATIONS

The present application claims priority under 35 U.S.C. §119(e) to U.S. Provisional Application 61/899,016, titled “SYSTEMS AND METHODS OF INCREASING MEDICATION ADHERENCE,” filed on Nov. 1, 2013, which is hereby incorporated herein by reference in its entirety.

### BACKGROUND

1. Technical Field

The technical field relates generally to systems and methods for managing information related to medications.

2. Background Discussion

Patients use various tools and techniques to adhere to medication regimens. These tools and techniques include rote memorization of medication schedules, hand-written reminders, printed instructions from physicians and pharmacists, and pill boxes.

### SUMMARY

Despite the advances described above, medication adherence continues to be a problem for many patients. Medication use has become more frequent and medication regimens have become more complex. To date, adherence approaches have not kept pace with this increased frequency and complexity.

Some embodiments disclosed herein manifest an appreciation that existing adherence approaches have significant limitations for patients, health care providers, insurance and pharmacy benefit manager organizations, pharmaceutical companies, and public health organizations that serve patients through health care or medical services.

For example, some embodiments manifest an appreciation that patients lack an efficient and inexpensive tool to manage medications, document medication adherence barriers, obtain patient-specific medication education and instructions, evaluate the impact of medication adherence on treatment progress, and communicate adverse events and treatment progress to health care providers and caregivers.

In addition, some embodiments manifest an appreciation that health care providers lack a tool that accounts for patient-specific adherence barriers when structuring medication regimens, assesses and monitors patients' medication effectiveness, medication adherence, and treatment progress between patient visits, and evaluates population-level and demographic-specific medication adherence and use data.

Moreover, some embodiments manifest an appreciation that insurance and pharmacy benefit manager organizations lack information to identify demographic-specific traits associated with reduced medication adherence, understand factors that influence patients' decisions to purchase and use medications, evaluate medication use data to target communication at non-adherent populations, and inform decisions on medication co-pay amounts and medication formularies.

Further, some embodiments manifest an appreciation that pharmaceutical companies lack population-level information to identify demographic-specific traits associated with abandoned medications, evaluate medication use data to identify new market segments and expand further into existing market segments, assess medication adherence and adverse events by disease type, and inform decisions on medication pricing and projected use.

Additionally, some embodiments manifest an appreciation that public health organizations lack a tool to rapidly gather current, population-level medication adherence and use data, determine the prevalence of incorrect or ineffective medication use, identify trends in medication adverse events, effectiveness and use, and inform decisions on medication-related public health interventions.

According to various aspects and embodiments, a system is configured to manage, monitor and structure medication regimens. More specifically, in some embodiments, the system executes processes that enable patients to coordinate and monitor medications before and after health care provider visits, record medication adherence barriers, receive patient-specific medication instructions and disease information, and increase engagement with health care providers and caregivers through remote, secure communication.

In some embodiments, the system is configured to enable health care providers to identify patients' adherence barriers before prescribing, resulting in regimens with a higher probability of patient adherence, increase productivity through efficient monitoring of patients' medication use between patient visits, improve patient outcomes through individual-level and population-level data on medication effectiveness and use, increase care coordination through remote, secure communication with patients, improve reconciliation of medication information at care transitions among health care providers, and reduce costs through fewer medication adherence-related patient readmissions and thereby fewer readmission penalties.

In some embodiments, the system is configured to enable health care benefits managers (e.g., insurance companies, government agencies, pharmacy benefit manager organizations, and other entities who pay for health care) to better assess and utilize medication data, improve patients' medication adherence through adherence-linked incentives and targeted communication, understand demographic-specific and population-level patient medication adherence barriers as well as variables influencing health care providers' prescription decisions, and reduce the cost and risk of insuring patients (e.g., patients who suffer from chronic disease) through increased patient medication adherence.

According to some embodiments, the system is configured to enable pharmaceutical companies to better assess and utilize medication data, identify and address the causes of abandoned prescriptions through demographic-specific and population-level data on medication adherence barriers, expand their customer base and improve market penetration and customer targeting through population-level medication use data, and improve their understanding of medication effectiveness, medication use, medication adherence barriers and medication-related adverse events through demographic-specific and population level information.

According to some embodiments, the system is configured to enable public health organizations to evaluate medication adherence, medication effectiveness, medication use, and disease prevalence at the demographic-specific and population levels, and better identify and respond to medication-related adverse events, health threats, and trends.

Still other aspects, embodiments and advantages of these example aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a block diagram including a system for managing medication;

FIG. 2 is a block diagram of a distributed computer system;

FIG. 3 is an example user interface screen;

FIG. 4 is an example user interface screen;

FIG. 5 is another example user interface screen;

FIG. 6 is another example user interface screen;

FIG. 7 is another example user interface screen;

FIG. 8 is another example user interface screen;

FIG. 9 is another example user interface screen;

FIG. 10 is another example user interface screen;

FIG. 11 is another example user interface screen;

FIG. 12 is another example user interface screen;

FIG. 13 is another example user interface screen;

FIG. 14 is another example user interface screen;

FIG. 15 is another example user interface screen;

FIG. 16 is another example user interface screen;

FIG. 17 is another example user interface screen;

FIG. 18 is another example user interface screen;

FIG. 19 is another example user interface screen;

FIG. 20 is another example user interface screen;

FIG. 21 is another example user interface screen;

FIG. 22 is another example user interface screen;

FIG. 23 is another example user interface screen;

FIG. 24 is another example user interface screen;

FIG. 25 is another example user interface screen;

FIG. 26 is another example user interface screen;

FIG. 27 is another example user interface screen;

FIG. 28 is another example user interface screen;

FIG. 29 is another example user interface screen;

FIG. 30 is another example user interface screen;

FIG. 31 is another example user interface screen;

FIG. 32 is another example user interface screen;

FIG. 33 is another example user interface screen;

FIG. 34 is another example user interface screen;

FIG. 35 is another example user interface screen;

FIG. 36 is another example user interface screen;

FIG. 37 is another example user interface screen;

FIG. 38 is another example user interface screen;

FIG. 39 is another example user interface screen;

FIG. 40 is another example user interface screen;

FIG. 41 is another example user interface screen;

FIG. 42 is another example user interface screen;

FIG. 43 is another example user interface screen;

FIG. 44 is another example user interface screen;

FIG. 45 is another example user interface screen;

FIG. 46 is another example user interface screen;

FIG. 47 is another example user interface screen;

FIG. 48 is another example user interface screen;

FIG. 49 is another example user interface screen;

FIG. 50 is another example user interface screen;

FIG. 51 is another example user interface screen;

FIG. 52 is another example user interface screen;

FIG. 53 is another example user interface screen;

FIG. 54 is another example user interface screen;

FIG. 55 is another example user interface screen;

FIG. 56 is another example user interface screen;

FIG. 57 is another example user interface screen;

FIG. 58 is another example user interface screen;

FIG. 59 is another example user interface screen;

FIG. 60 is another example user interface screen;

FIG. 61 is another example user interface screen;

FIG. 62 is another example user interface screen; and

FIG. 63 is a flow diagram of a process for managing medication.

### DETAILED DESCRIPTION

Some aspects and embodiments disclosed herein include apparatus and processes for directing, monitoring, managing, tracking, and reporting adherence to medication regimens ordered by health care providers, such as physicians (including board certified physicians and physicians in training such as those in Internship, Residency and Fellowship medical training programs), physician assistants, nurses (including, but not limited to nurse practitioners, registered nurses, licensed practical nurses and licensed vocational nurses), medical assistants, physical therapists, dentists, and other providers of health care services. For example, according to one aspect, a computer system is configured to provide a variety of interfaces through which the computer system exchanges information related to medication regimens (“medication information”) with various interested parties. These interested parties may include health care providers, patients, and third parties, such as benefits managers, pharmaceutical companies, and public health organizations. In some embodiments, the medication information may include education, information, and instructions regarding a prescribed course of medication; education, information, and instructions regarding a prescribed medical procedure; education, information, and instructions regarding health or medical conditions or diseases; education, information, and instructions regarding use of the computer system; and analyzed and summarized medication adherence and medication efficacy data, including treatment outcomes and effectiveness of medications on diseases or patients at the individual level or population level.

By receiving medication information, analyzing the medication information, and distributing the analyzed medication information to the interested parties, the aspects and embodiments disclosed herein enable all of the interested parties to access and utilize medication data not available through conventional medication management tools. For example, the aspects and embodiments disclosed herein enable patients to better manage and monitor medications through tailored guidance and to receive medications from health care providers to which the patient is most likely to adhere. In addition, the aspects and embodiments disclosed herein enable health care providers to improve their awareness and understanding of patients' medication adherence barriers before structuring or prescribing medication regimens. Many other benefits are appreciated and realized in the following detailed description.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

### Medication Management System

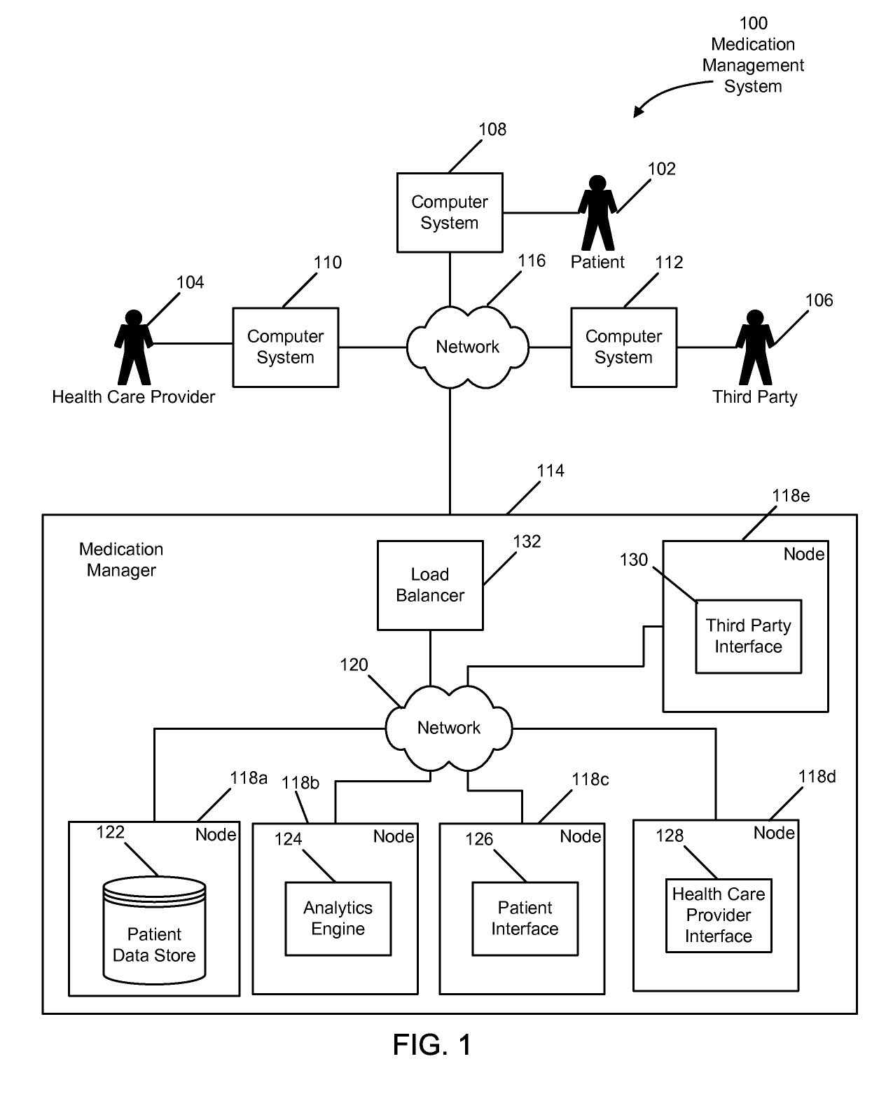

Various embodiments utilize one or more specially configured computer systems to monitor, manage, analyze, and report on medication regimens. FIG. 1 illustrates one of these embodiments, a medication management system 100. As shown, FIG. 1 includes a patient 102, a health care provider 104, and a third party 106. It is appreciated that each of the individual users illustrated in FIG. 1 (e.g., the patient 102, the health care provider 104, and the third party 106) may include a plurality of users. For example, the third party 106 may include one or more benefits managers, pharmaceutical company representatives, public health organization representatives or other interested parties.

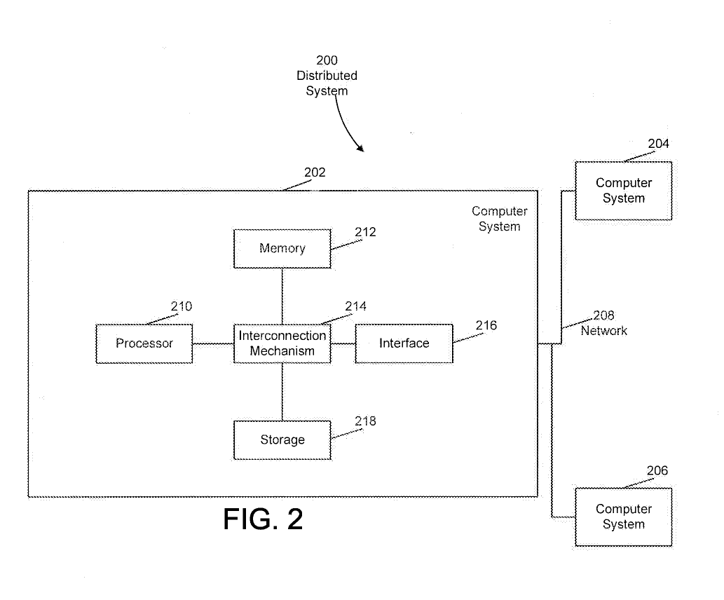

FIG. 1 further includes a communication network 116 and computer systems 108, 110, 112, and 114, each of which include one or more computer systems, such as the computer system described below with reference to FIG. 2. As illustrated in FIG. 1, the computer systems 108, 110, 112, and 114 are coupled together and exchange (e.g., send or receive) information via the network 116. The network 116 may include any communication network through which devices may exchange information. For example, the network 116 may be a public network, such as the Internet, and may include other public or private networks such as LANs, WANs, extranets, intranets, and cloud computing systems. The network 116 may also include cellular networks such as CMDA, EvDO, GSM, and iDEN networks.

As illustrated in FIG. 1, the computer system 114 implements a medication manager component. The medication manager component includes a load balancer 132, nodes 118a-118e, and a communication network 120. The load balancer 132, the nodes 118a-118e, and the communication network 120 each include one or more computer systems, such as the computer system described below with reference to FIG. 2. As shown in FIG. 1, the load balancer 132 and the nodes 118a-118e are coupled together and exchange information via the network 120. Like the network 116 described above with reference to FIG. 1, the network 120 may include any communication network through which member computer systems may exchange data. Further, as illustrated in FIG. 1, the node 118a implements a patient data store 122, the node 118b implements an analytics engine 124, the node 118c implements a patient interface 126, the node 118d implements a health care provider interface 128, and the node 118e implements a third party interface 130.

In one embodiment illustrated by FIG. 1, the load balancer 132 provides load balancing services to the other components of the medication manager component. The nodes 118a-118e provide computing resources to various processes executed by the medication manager component. For example, each of the nodes 118a-118e provides data storage and retrieval functionality to locally and remotely executing processes. In addition, the nodes 118c-118e implement web server functionality in support of the patient interface 126, the health care provider interface 128, and the third party interface 130. This web server functionality may serve content using any suitable protocol including, among others, HTTP, SMTP, IMAP, and POP, and any suitable data formatting standard including, among others, HTML, DHTML, XML and MIME.

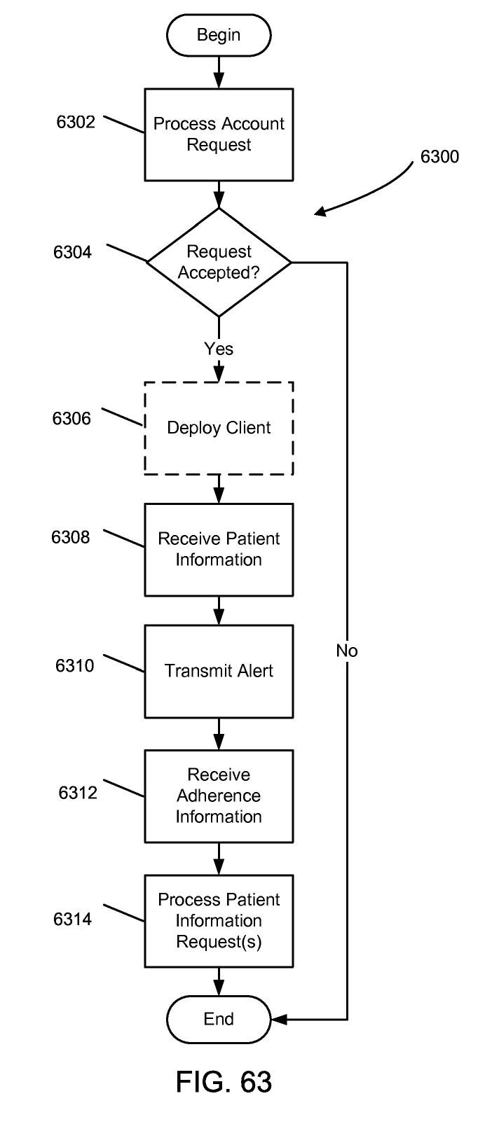

According to various embodiments, the medication manager component is configured to execute one or more medication management processes. Examples of acts executed within these processes include configuring new patient accounts, instructing patients to adhere to medication regimens, collecting and exchanging adherence information, collecting and exchanging patient health or medical history information, collecting and exchanging medication information, collecting and exchanging medication use, effectiveness and treatment information, collecting and exchanging medication adverse event or side effect information, collecting and exchanging patient health insurance, caregiver and surrogate information, providing educational or reference information on medications, diseases or conditions, analyzing information stored in the patient data store 122, and reporting analyzed information to users. One particular example of a medication management process 6300 executed by the medication management system 100 is described further below with reference to FIG. 63.

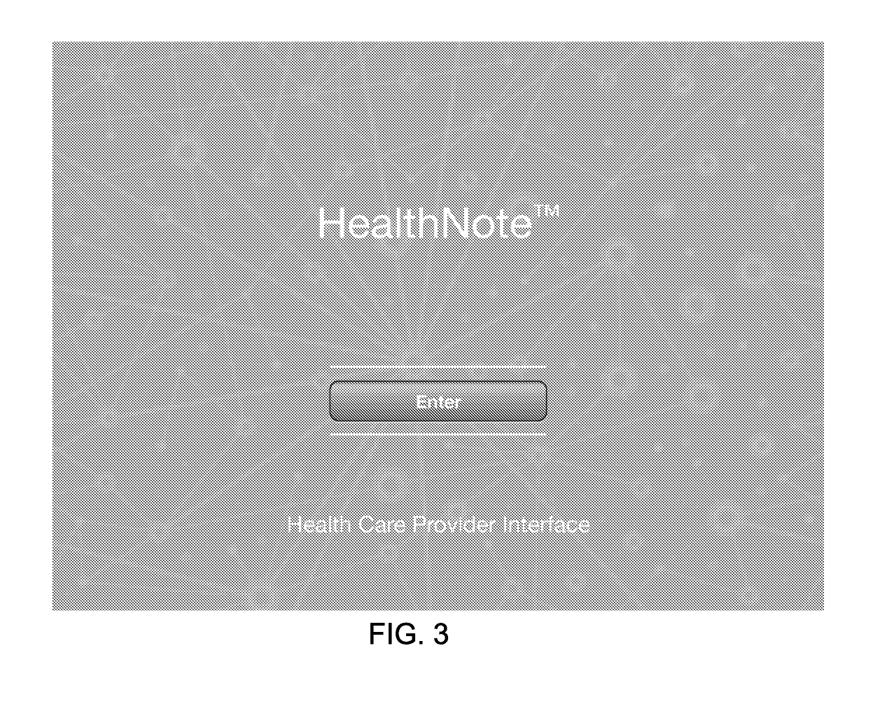

In some embodiments, the medication manager component is also configured to process patient information requests received via the interfaces described herein (e.g., the patient interface 126, the health care provider interface 128, and the third party interface 130). These patient information requests may include instructions to create, read, update, or delete any patient or medication information within the patient data store 122. In response to receiving a patient information request, the interface receiving the request validates and implements the request by accessing data stored in the patient data store 122. This data may include patient information, adherence information, disease information, and medication information. Examples of patient information requests, patient information, adherence information, disease information, and medication information are described further below with reference to FIGS. 3-62.

Each of the interfaces described herein is configured to exchange information with a variety of external entities, such as users or external systems. For example, according to one embodiment, each of the patient interface 126, the health care provider interface 128, and the third party interface 130 implements a system interface that exchanges information with external systems according to a predefined protocol.

In one embodiment, each of the interfaces 126, 128, and 130 is configured to provide a user interface to each of the users 102, 104, and 106, respectively, via the network 116. For instance in one embodiment, the patient interface 126 is configured to provide a user interface to the patient 102 via the network 116 and the computer system 108. In some of these embodiments, the user interface includes a browser-based user interface served by the node 118c and rendered on the computer system 108. In other embodiments, the user interface includes a specialized client program that executes outside of a browser environment, such as an application program executing on a mobile device. Each of the interfaces described herein may be implemented using either architecture described above or using a different architecture, as the embodiments described herein are not limited to a particular design or architecture. Each of the interfaces described herein may include various interface elements (e.g., screens, windows, buttons, boxes, and other elements) arranged according to a variety of designs and metaphors. Examples of interface elements provided by the interfaces and the information exchanged via the interfaces are described further below with reference to FIGS. 3-62.

According to an embodiment in accord with FIG. 1, the analytics engine 124 analyzes individual patient data stored in the patient data store 122 to produce a variety of summary data for reporting via the interfaces described herein. For example, in some embodiments, the analytics engine 124 may determine a likelihood (e.g., an adherence rate) that one or more patients may adhere to one or more medication regimens based on demographic, historical, or other information descriptive of the patient that is stored in the patient data store 122. These likelihoods and other analyzed medication information may be provided by various interface elements, such as the elements described below with reference to FIGS. 3-62. The analytics engine 124 may run periodically or in response to a request received from one of the interfaces described herein. Additional examples of the summary data produced by the analytics engine 124 are described further below with reference to FIGS. 3-62.

Information may flow between the components illustrated in FIG. 1, or any of the elements, components and subsystems disclosed herein, using a variety of techniques. Such techniques include, for example, passing the information over a network using standard protocols, such as TCP/IP or HTTP or HTTPS, passing the information between modules in memory and passing the information by writing to a file, database, data store, or some other nonvolatile data storage device, among others. In addition, pointers or other references to information may be transmitted and received in place of, in combination with, or in addition to, copies of the information. Conversely, the information may be exchanged in place of, in combination with, or in addition to, pointers or other references to the information. Other techniques and protocols for communicating information may be used without departing from the scope of the examples and embodiments disclosed herein.

Data stores within the medication management system 100, such as the patient data store 122 may take the form of any logical construction capable of storing information on a computer readable medium including flat files, indexed files, hierarchical databases, relational databases or object oriented databases. The data may be modeled using unique and foreign key relationships and indexes. The unique and foreign key relationships and indexes may be established between the various fields and tables to ensure both data integrity and data interchange performance.

Embodiments of the medication management system 100 and the medication manager component are not limited to the particular configurations of components illustrated in FIG. 1. These configurations are included for the purposes of illustration only. It is to be appreciated that various examples and embodiments utilize a variety of hardware components, software components, and combinations of hardware and software components that are configured to perform the processes and functions described herein. In addition, the hardware components described above may be virtualized. Thus the scope of the embodiments disclosed herein is not limited to a particular set of hardware, software, or a combination thereof.

### User Interfaces

Various embodiments disclosed herein implement a health care provider interface, such as the health care provider interface 128 described above with reference to FIG. 1, through which a medication manager component, such as the medication manager component described above with reference to FIG. 1, receives and processes patient information requests. In some embodiments, the health care provider interface exchanges information with a health care provider, such as the health care provider 104 described above with reference to FIG. 1, via a computer system that is associated with the health care provider, such as the computer system 110 described above with reference to FIG. 1.

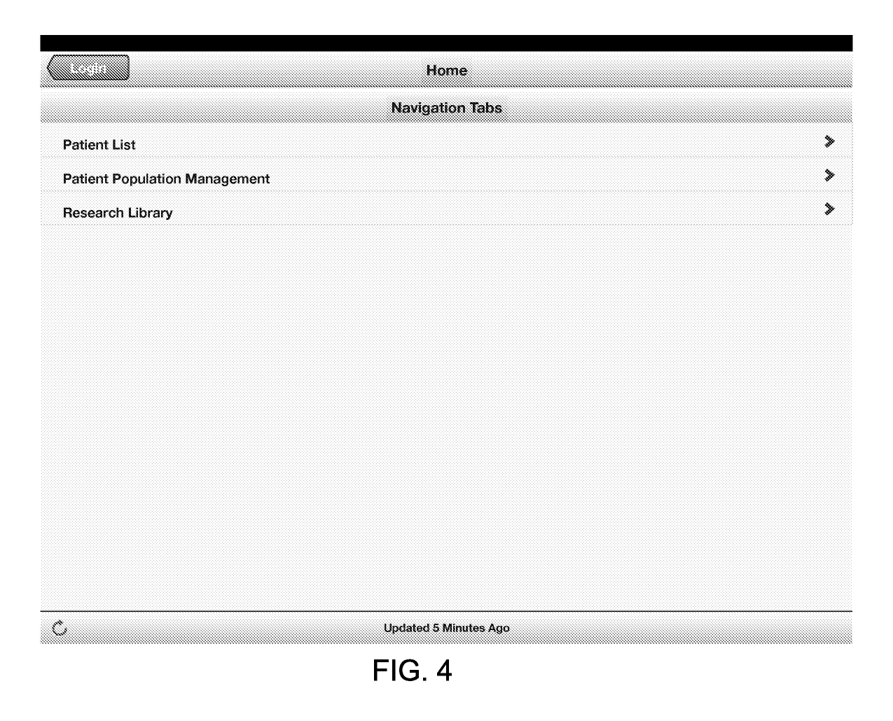

FIG. 3 illustrates a login screen provided by the health care provider interface. As shown in FIG. 3, the login screen includes an enter button. In response to receiving input indicating selection of the enter button, the health care provider interface requests authentication credentials. If the health care provider interface does not receive authentication credentials associated with a configured health care provider account within a predetermined timeframe, the health care provider interface denies entry to other screens. Otherwise, the health care provider interface provides a home screen as illustrated in FIG. 4.

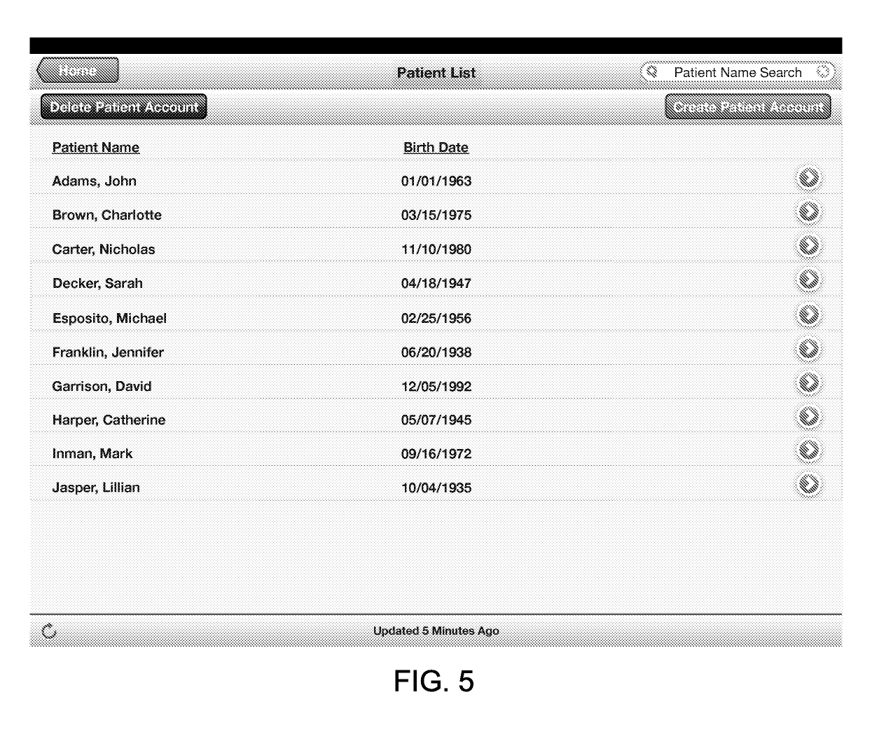

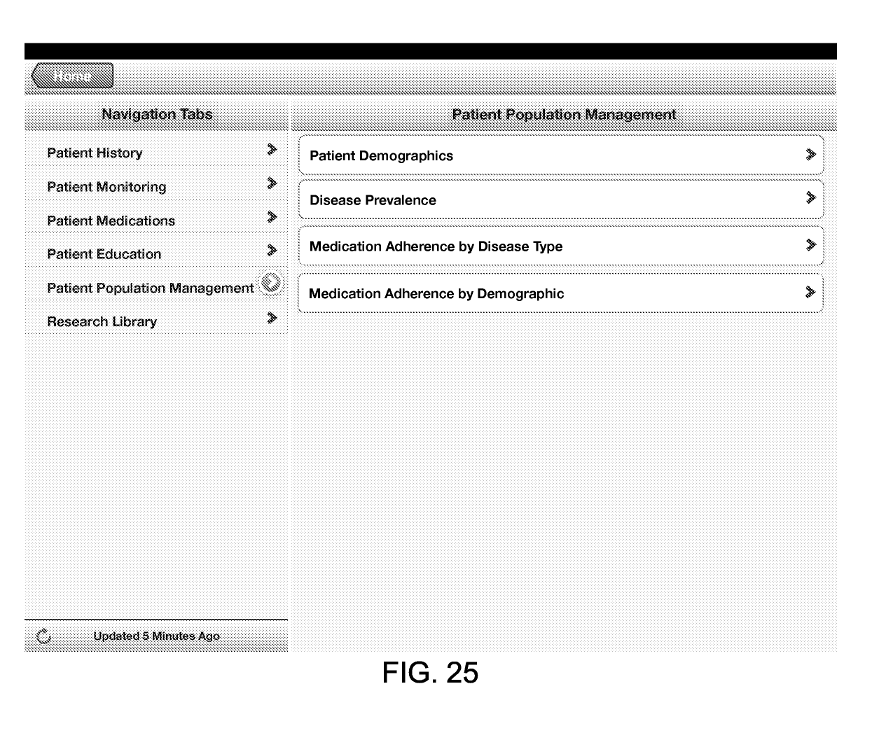

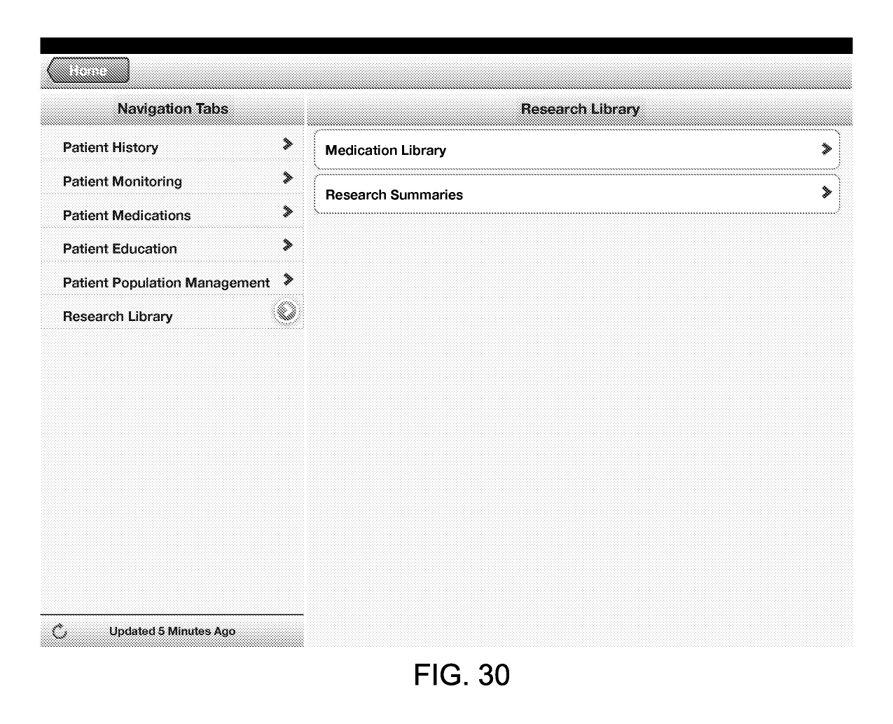

As shown in FIG. 4, the home screen includes the following navigation tabs: patient list, patient population management, and research library. In response to receiving input indicating selection of the patient list tab, the health care provider interface provides a patient list screen as illustrated in FIG. 5. In response to receiving input indicating selection of the patient population management tab, the health care provider interface provides a patient population management screen as illustrated in FIG. 25. In response to receiving input indicating selection of the research library tab, the health care provider interface provides a research library screen as illustrated in FIG. 30.

The home screen also includes a refresh button in the lower left portion of the screen. In response to receiving input indicating selection of the refresh button, the health care provider interface will redisplay the information presented on the home screen, thereby changing the information to reflect any changes in the information that the home screen is configured to display. In some embodiments, the health care provider interface will also periodically and automatically refresh the home screen. In some embodiments, the screens illustrated in FIGS. 5-32 and 35-55 also include this functionality.

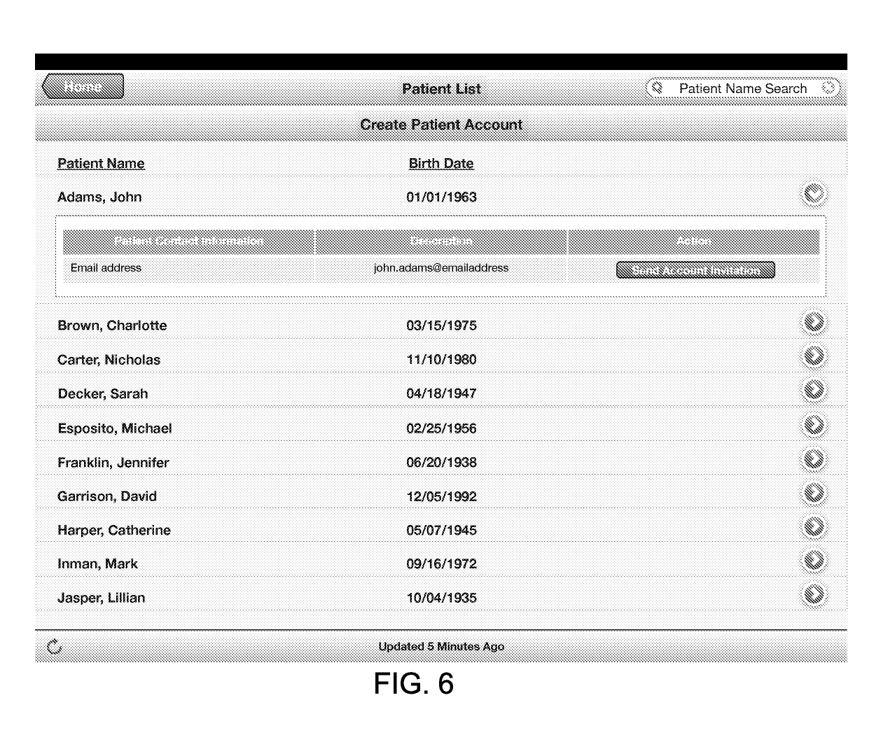

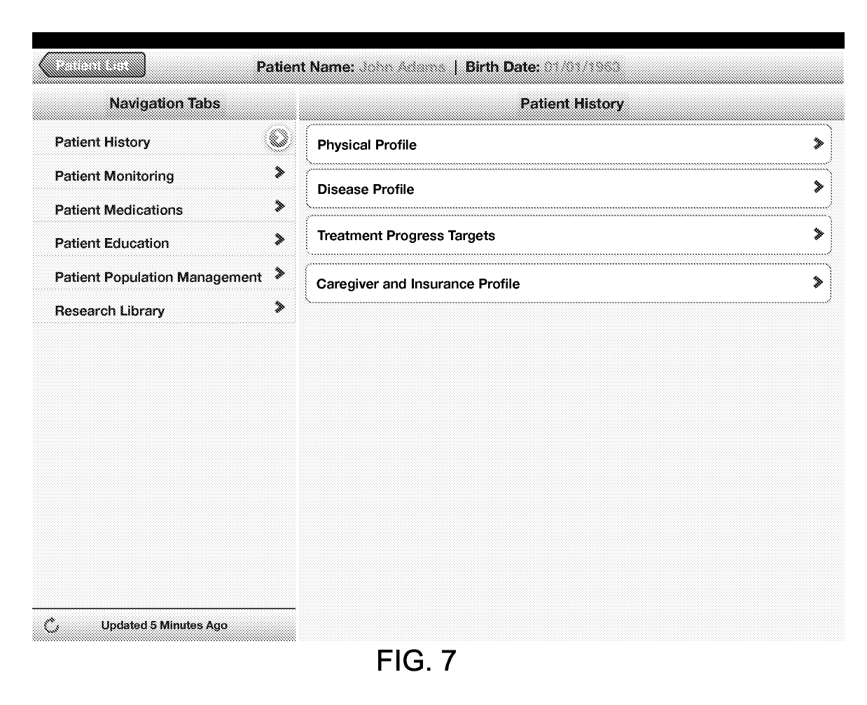

As shown in FIG. 5, the patient list screen includes a search box and a list of patients. In some embodiments, information presented on the patient list screen will include the birth date associated with the patient identifier. The patient list screen also includes a create patient account button in the upper right portion of the screen. In response to receiving input indicating selection of the create patient account button, the health care provider interface displays a create patient account screen as illustrated in FIG. 6. The patient list screen also includes a delete patient account button in the upper left portion of the screen. In response to receiving input indicating selection of the delete patient account button, the health care provider interface displays a user interface element to select a patient identifier and remove the account associated with the selected patient identifier. In response to receiving input indicating selection of a patient identifier via the search box or the list of patients, the health care provider interface displays a patient information screen as illustrated in FIG. 7.

As shown in FIG. 6, the create patient account screen includes a search box and a list of patients. In some embodiments, information presented on the create patient account screen will include the birth date associated with the patient identifier. In response to receiving input indicating selection of a patient identifier via the search box or the list of patients, the health care provider interface displays patient contact information and a send account invitation button. In some embodiments, the patient contact information presented will include the email address associated with the selected patient identifier. In response to receiving input indicating selection of the send account invitation button, the health care provider interface initiates the process of establishing a user account for a patient which the patient accesses through the patient interface. In response to receiving input including the requested patient account information, the health care provider interface creates an account for the patient and transmits a notification of the account setup process to the email address included in the patient account information. The notification may include a link to a login screen of a patient interface, such as the patient interface 126 described above with reference to FIG. 1.

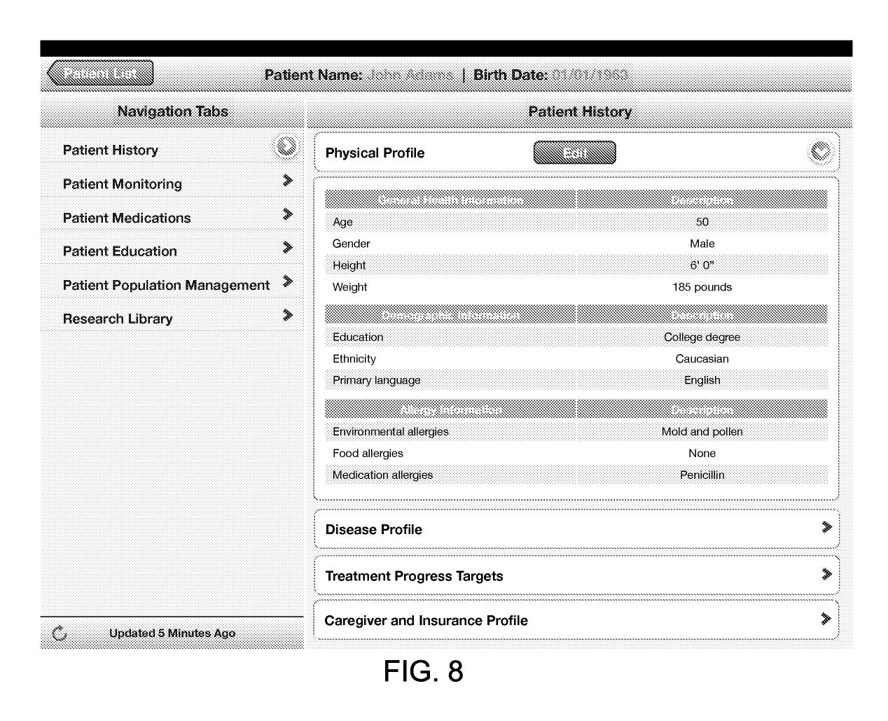

As shown in FIG. 7, the patient information screen displays the name and date of birth of a patient identified by the selected patient identifier, as do the screens illustrated in FIGS. 8-24. The patient information screen also includes the following navigation tabs: patient history, patient monitoring, patient medications, patient education, patient population management, and research library, as do the screens illustrated in FIGS. 8-32, and links to patient history information.

As illustrated in FIG. 7, the links to the patient history information include a link to a physical profile associated with the selected patient identifier, a link to a disease profile associated with the selected patient identifier, a link to treatment progress targets associated with the selected patient identifier, and a link to a caregiver and insurance profile associated with the selected patient identifier. In response to receiving input indicating selection of the physical profile link, the health care provider interface provides a physical profile screen as illustrated in FIG. 8. In some embodiments, selected information in the patient history, patient monitoring, patient medications, patient education, patient population management, and research library fields may be entered manually via the edit button or populated automatically through a system interface (e.g. bulk data interface, application program interface, etc.) to a health care provider's electronic health record or other electronic record system.

As shown in FIG. 8, the physical profile screen includes an edit button and displays general health information, demographic information, and allergy information associated with the selected patient identifier. In response to receiving input indicating selection of the edit button, the health care provider interface enables the fields displaying the general health information, the demographic information, and the allergy information to receive input. In response to receiving input within the fields displaying the general health information, the demographic information, or the allergy information, the health care provider interface stores the general health information, the demographic information, and the allergy information in a patient data store, such as the patient data store 122 described above with reference to FIG. 1. In some embodiments, the health care provider interface may request confirmation prior to storing the general health information, the demographic information, and the allergy information.

As shown in FIG. 8, the general health information displayed by the physical profile screen includes age, gender, height, and weight. The demographic information includes education, ethnicity, and primary language. The allergy information includes environmental allergies, food allergies, and medication allergies. Other embodiments may store and display additional or alternative physical profile information and the embodiments disclosed herein are not limited to a particular set of physical profile information.

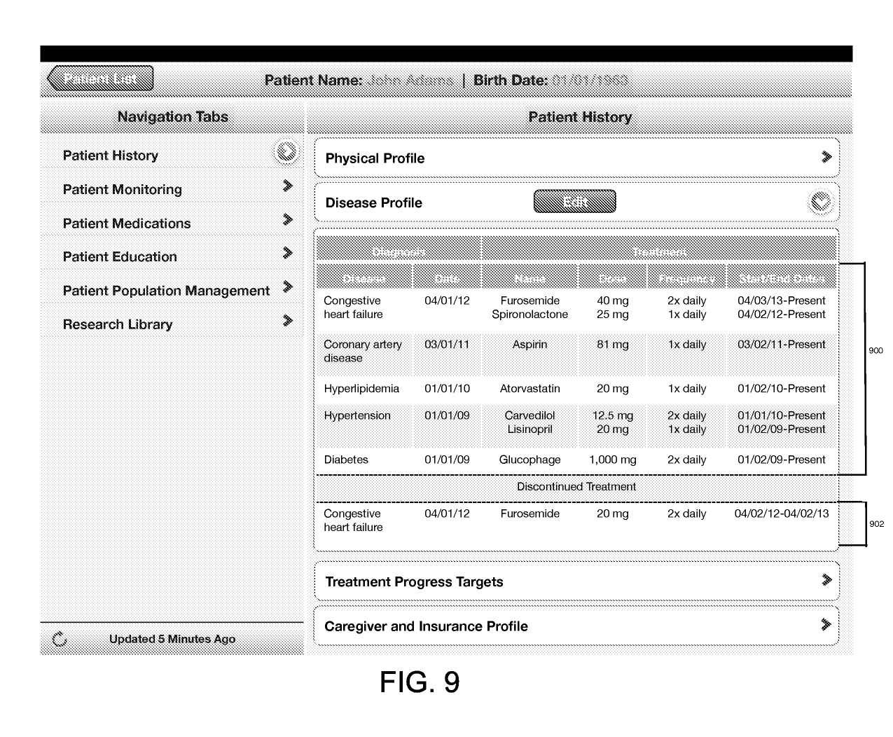

Returning to FIG. 7, in response to receiving input indicating selection of the disease profile link, the health care provider interface provides a disease profile screen as illustrated in FIG. 9.

As shown in FIG. 9, the disease profile screen includes an edit button and displays disease diagnosis and treatment information associated with the selected patient identifier. The disease profile screen includes an active area 900 and an inactive area 902. The disease diagnosis and treatment information displayed by the disease profile screen includes previously diagnosed diseases, dates of the diagnosis, medications prescribed, dosages, dosage frequencies, dates that medication dosages were initiated, and dates that medication dosages were terminated. In response to receiving input indicating selection of the edit button, the health care provider interface enables the fields displaying the disease diagnosis and treatment information to receive input. In response to receiving input within the fields displaying the disease diagnosis and treatment information, the health care provider interface stores the disease diagnosis and treatment information in the patient data store. In some embodiments, the health care provider interface may request confirmation prior to storing the disease diagnosis and treatment information. Other embodiments may store and display additional or alternative disease profile information and the embodiments disclosed herein are not limited to a particular set of disease profile information.

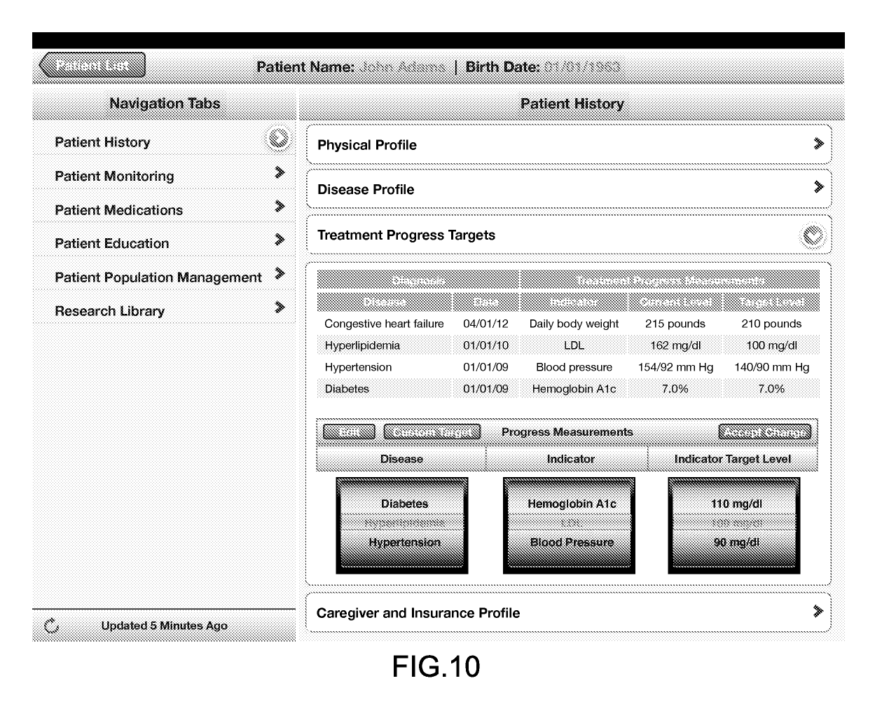

Returning to FIG. 7, in response to receiving input indicating selection of the treatment progress targets link, the health care provider interface provides a treatment progress targets screen as illustrated in FIG. 10.

As shown in FIG. 10, the treatment progress targets screen displays diagnosis and treatment progress measurements information associated with the selected patient identifier. The diagnosis and treatment progress measurements information displays previously diagnosed diseases, dates of the diagnosis, biological or non-biological indicators of treatment progress associated with a diagnosis, current levels of biological or non-biological indicators of treatment progress associated with a diagnosis, and target levels of biological or non-biological indicators of treatment progress associated with a diagnosis.

As shown in FIG. 10, the treatment progress targets screen also includes a progress measurements area that includes an edit button, a custom target button and an accept change button. The progress measurements area is configured to receive input descriptive of progress for the selected patient identifier. In response to receiving input indicating selection of the edit button, the health care provider interface enables the fields displaying the disease, indicator, and indicator target level information to receive input. In response to selecting the custom target button, the health care provider interface enables the fields displaying information in the progress measurements area to accept information entered through interfaces that include, but are not limited to, a list, search box, or virtual keyboard. In response to receiving input within the fields displaying the disease, indicator, or indicator target level information and upon selection of the accept change button, the health care provider interface stores the disease, indicator, or indicator target level information in the patient data store. Other embodiments may store and display additional or alternative treatment progress targets information and the embodiments disclosed herein are not limited to a particular set of treatment progress targets information.

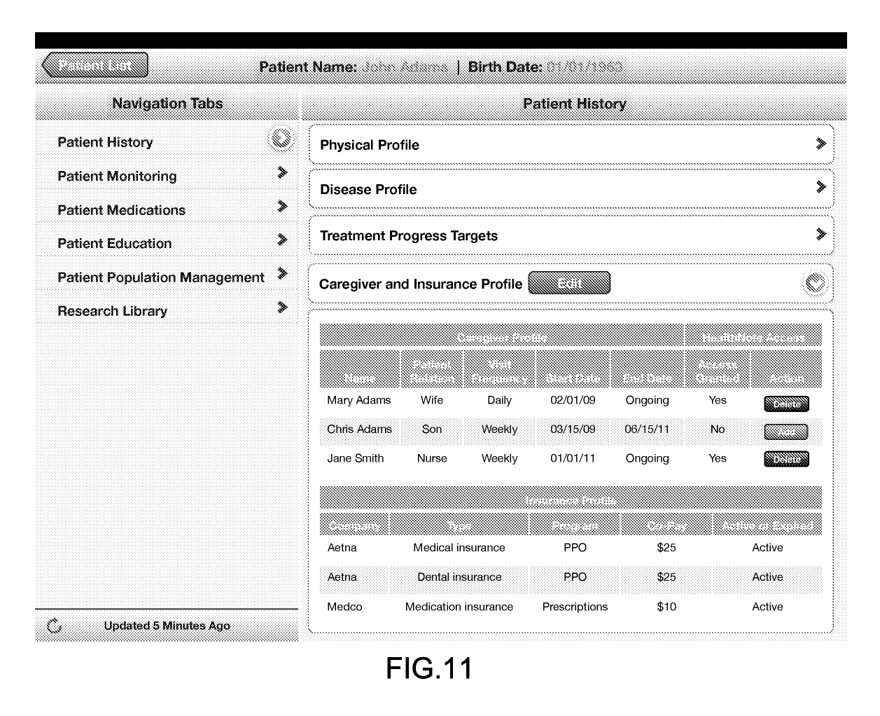

Returning to FIG. 7, in response to receiving input indicating selection of the caregiver and insurance profile link, the health care provider interface provides a caregiver and insurance profile screen as illustrated in FIG. 11.

As shown in FIG. 11, the caregiver and insurance profile screen includes an edit button and displays caregiver information and insurance information associated with the selected patient identifier. In response to receiving input indicating selection of the edit button, the health care provider interface enables the fields displaying the caregiver information and the insurance information to receive input. In response to receiving input within the fields displaying the caregiver information and the insurance information, the health care provider interface stores the caregiver information and the insurance information in the patient data store 122. In some embodiments, the health care provider interface may request confirmation prior to storing the caregiver information and the insurance information.

As shown in FIG. 11, the caregiver information displayed by the caregiver and insurance profile screen includes names of the caregivers, relations of the caregivers to the patient identified by the selected patient identifier, the frequency with which care is provided, dates upon which giving of care was initiated, and dates upon which giving of care was terminated. The caregiver information also includes an access area that indicates whether a caregiver has been granted access to the patient interface for the selected patient identifier. Further, the access area within the caregiver information includes an add button and a delete button. In response to receiving input indicating selection of the add button, the health care provider interface initiates the process of establishing a user account for the caregiver which the caregiver accesses through the patient interface. In response to receiving input including the requested caregiver account information, the health care provider interface creates an account for the caregiver and transmits a notification of the account setup process to the email address included in the caregiver account information. The notification may include a link to a login screen of a patient interface, such as the patient interface 126 described above with reference to FIG. 1. In response to receiving input indicating selection of the delete button, the health care provider interface removes one or more caregivers selected in the caregiver profile information and from the patient data store 122 described above with reference to FIG. 1.

The insurance information includes insurer, type of insurance, insurance program, co-pay amount, and whether the insurance is active or expired. Other embodiments may store and display additional or alternative caregiver and insurance profile information and the embodiments disclosed herein are not limited to a particular set of caregiver and insurance profile information.

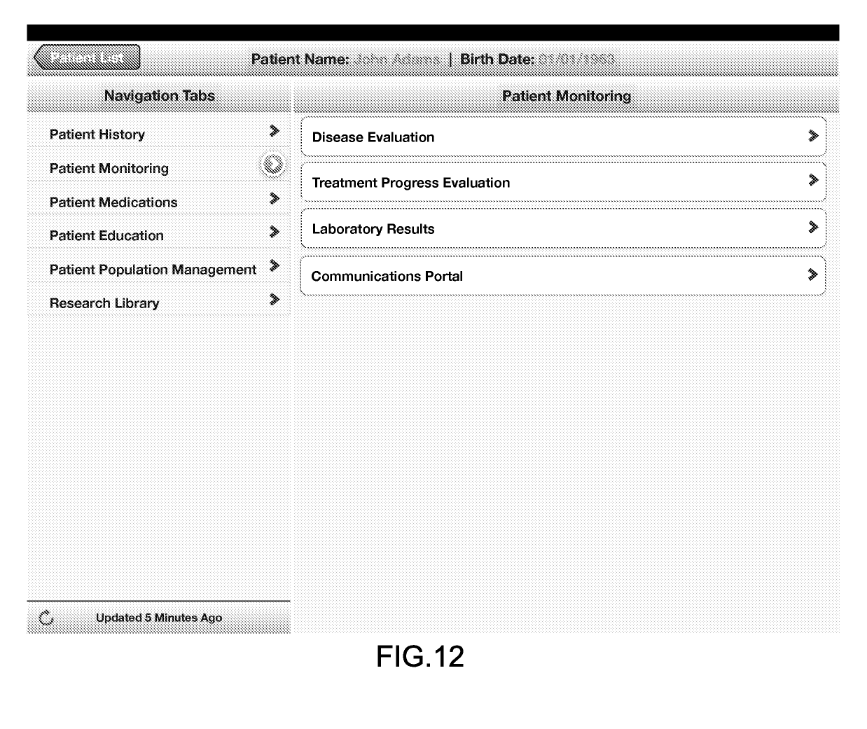

Returning to FIG. 7 in response to receiving input indicating selection of the patient monitoring navigation tab, the health care provider interface displays a patient monitoring screen as illustrated in FIG. 12.

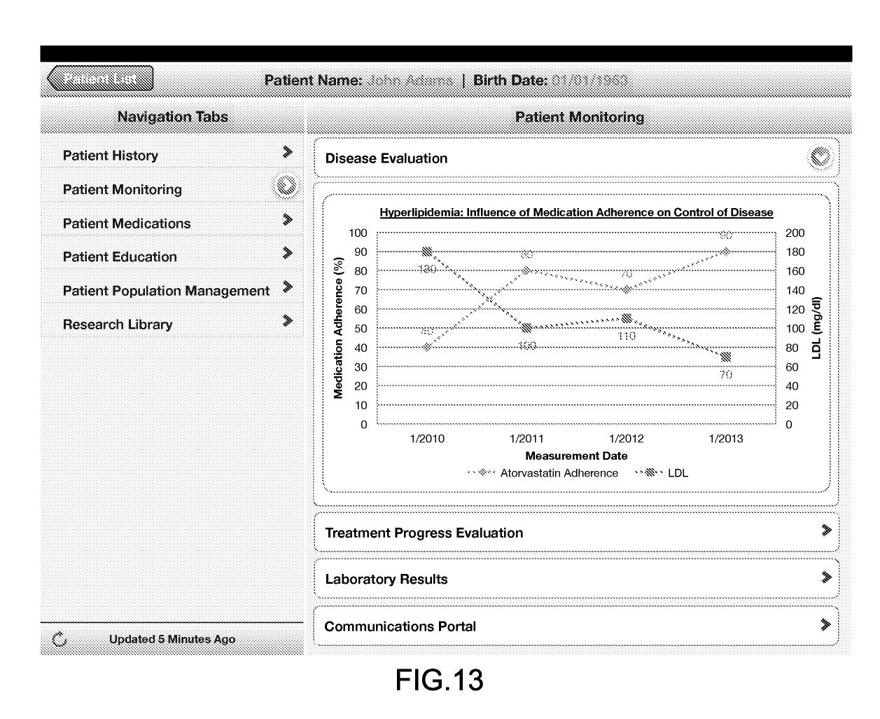

As illustrated in FIG. 12, the patient monitoring screen includes a link to a disease evaluation associated with the selected patient identifier, a link to a treatment progress evaluation associated with the selected patient identifier, a link to laboratory results associated with the selected patient identifier, and a link to a communications portal associated with the selected patient identifier. In response to receiving input indicating selection of the disease evaluation link, the health care provider interface provides a disease evaluation screen as illustrated in FIG. 13.

The disease evaluation information displayed by the disease evaluation screen may include a variety of metrics stored within the patient data store 122 and displayed within various representations, such as graphs, tables, reports and other data presentation devices. Some of these metrics may be specific to one or more patients. Other metrics may be summaries calculated by an analytics engine, such as the analytics engine 124 described above with reference to FIG. 1, from information stored in the patient data store. As shown in FIG. 13, the disease evaluation information displayed by the disease evaluation screen includes a line graph that illustrates a relationship between the LDL cholesterol of the patient and the medication adherence of the patient over time. Other embodiments may display additional or alternative disease evaluation information and the embodiments disclosed herein are not limited to a particular set of disease evaluation information.

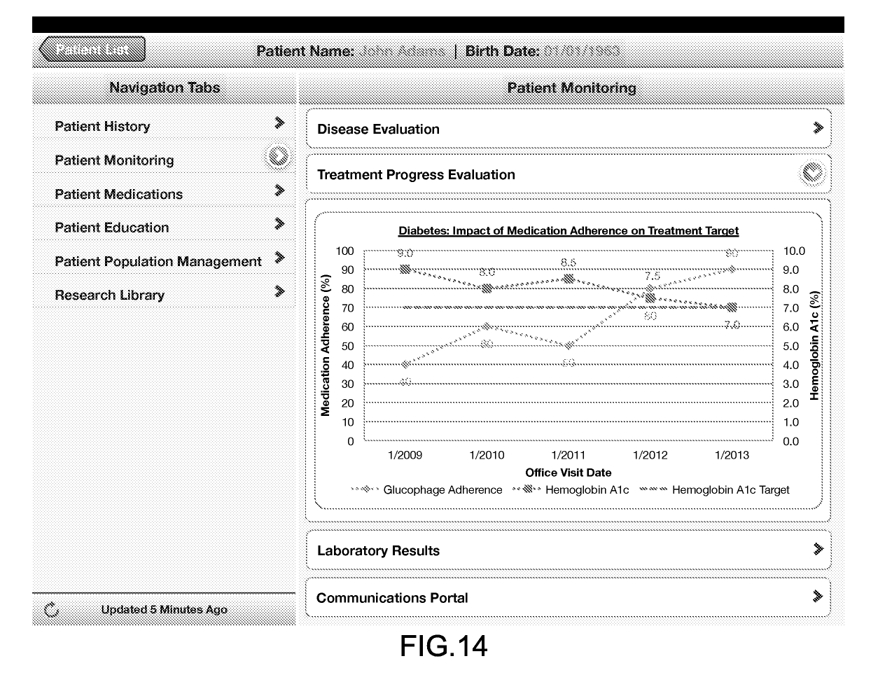

Returning to FIG. 12, in response to receiving input indicating selection of the treatment progress evaluation link, the health care provider interface provides a treatment progress evaluation screen as illustrated in FIG. 14.

The treatment progress evaluation information displayed by the treatment progress evaluation screen may include a variety of metrics stored within the patient data store 122 and displayed within various representations, such as graphs, tables, reports and other data presentation devices. Some of these metrics may be specific to one or more patients. Other metrics may be summaries calculated by the analytics engine 124 from information stored in the patient data store 122. As shown in FIG. 14, the treatment progress evaluation information displayed by the treatment progress evaluation screen includes a line graph that illustrates a relationship between the hemoglobin A1c level of the patient and the medication adherence of the patient over time. Other embodiments may display additional or alternative treatment progress evaluation information and the embodiments disclosed herein are not limited to a particular set of treatment progress evaluation information.

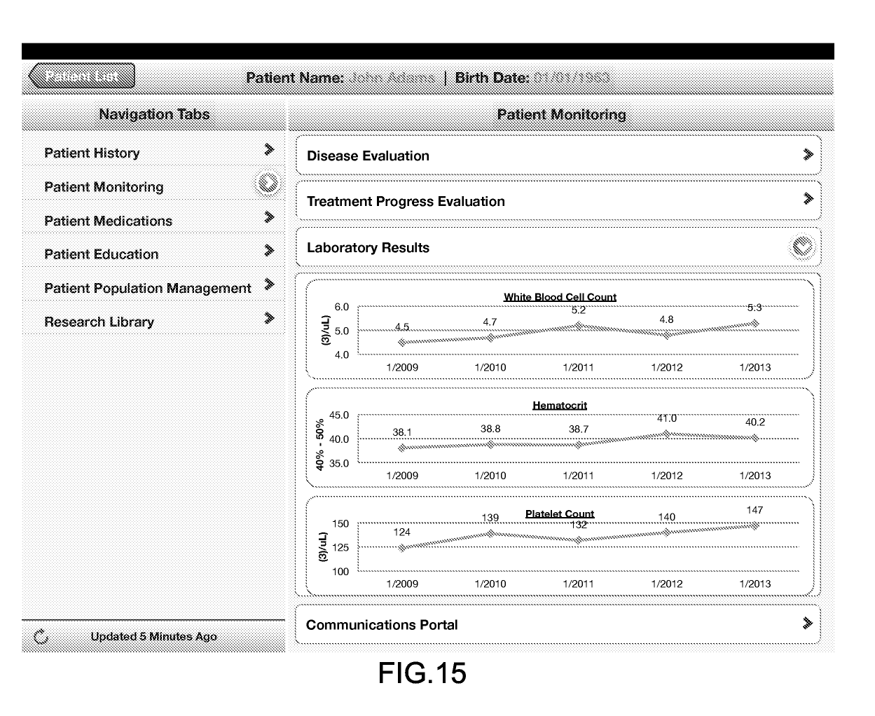

Returning to FIG. 12, in response to receiving input indicating selection of the laboratory results link, the health care provider interface provides a laboratory results screen as illustrated in FIG. 15.

The laboratory results information displayed by the laboratory results screen may include a variety of metrics stored within the patient data store 122 and displayed within various representations, such as graphs, tables, reports and other data presentation devices. Some of these metrics may be specific to one or more patients. Other metrics may be summaries calculated by the analytics engine 124 from information stored in the patient data store 122. As shown in FIG. 15, the laboratory results information displayed by the laboratory results screen includes a line graph that illustrates the white blood cell count of the patient, the hematocrit of the patient, and the platelet count of the patient over time. Other embodiments may display additional or alternative laboratory results information and the embodiments disclosed herein are not limited to a particular set of laboratory results information.

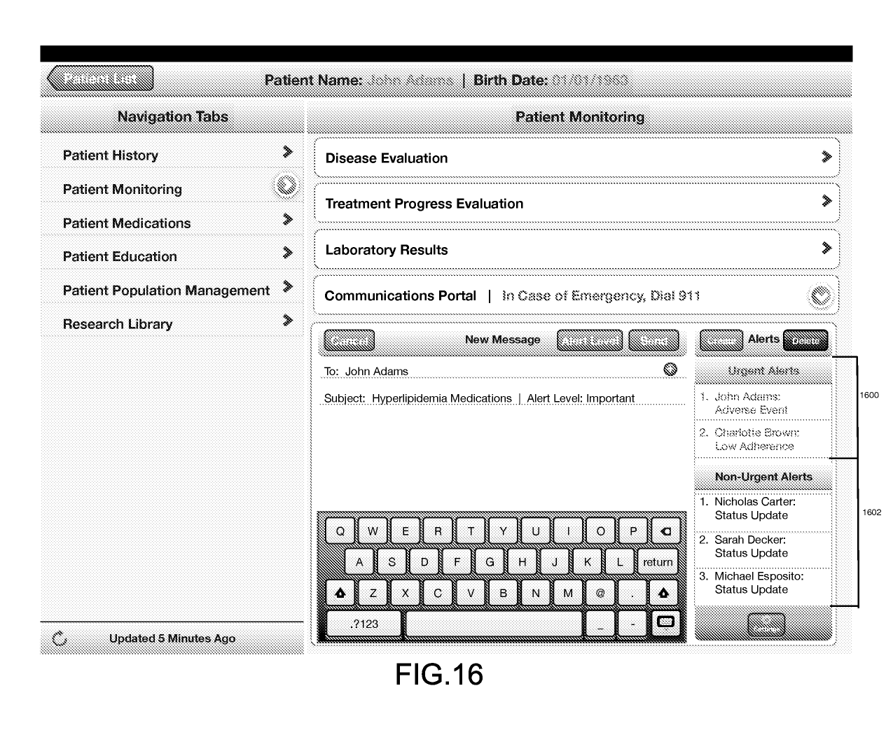

Returning to FIG. 12, in response to receiving input indicating selection of the communications portal link, the health care provider interface provides a communications portal screen as illustrated in FIG. 16.

As shown in FIG. 16, the communications portal screen includes a message area 1600 and an alert area 1602. The message area 1600 includes a virtual keyboard, a new message area, a send button, an alert level button, and a cancel button. The alert area 1602 includes an urgent alerts section and a non-urgent alerts section. The alert area 1602 also includes a create button, a delete button, and a settings button.

In an embodiment illustrated by FIG. 16, the health care provider interface is configured to receive input via the new message area indicating one or more patients to whom a message is addressed, input indicating the subject of the message, and a body of the message via the virtual keyboard. In response to receiving input indicating selection of the send button, the health care provider interface is configured to send the message to the patient or patients to whom the message is addressed. In response to receiving input indicating selection of the alert level button, the health care provider interface is configured to indicate the alert level (e.g., important) as indicated by an alert level in the subject area of the message. In response to receiving input indicating selection of the cancel button, the health care provider interface is configured to reset the new message area. In some embodiments, this screen may also include a pull-down or scroll menu that enables health care providers to select and send a pre-formatted message or response to a patient. When a pre-formatted message or response is selected, the health care provider interface automatically populates the title and content of the message being sent to the patient without requiring additional typing on the virtual keyboard.

In another embodiment illustrated by FIG. 16, the health care provider interface is configured to display current and past urgent and non-urgent alerts in the alerts area 1602. In response to receiving input indicating selection of the create button, the health care provider interface provides a set of interface elements through which the health care provider interface receives input descriptive of an alert. The information descriptive of an alert may include an alert message, an alert type (e.g., urgent or non-urgent), and one or more patients to whom the alert is addressed. Example alert messages include messages descriptive of adverse events, low adherence, and status updates. In response to receiving input indicating selection of the delete button, the health care provider interface deletes an alert currently selected in the alerts area 1602 from the system. In response to receiving input indicating selection of the settings button, the health care provider interface displays one or more additional user interface elements through which the health care provider interface can receive input selecting from which patients the health care provider wishes to receive alerts, the types of events that are classified as an urgent or non-urgent alert, to whom each classification of alert should be routed (such as the physician or a different health care provider) and the channel through which, and frequency with which, each classification of alert is transmitted to the health care provider (such as through audible, visual, electronic message or other means). Other embodiments may display additional or alternative message or alert information and the embodiments disclosed herein are not limited to a particular set of message or alert information.

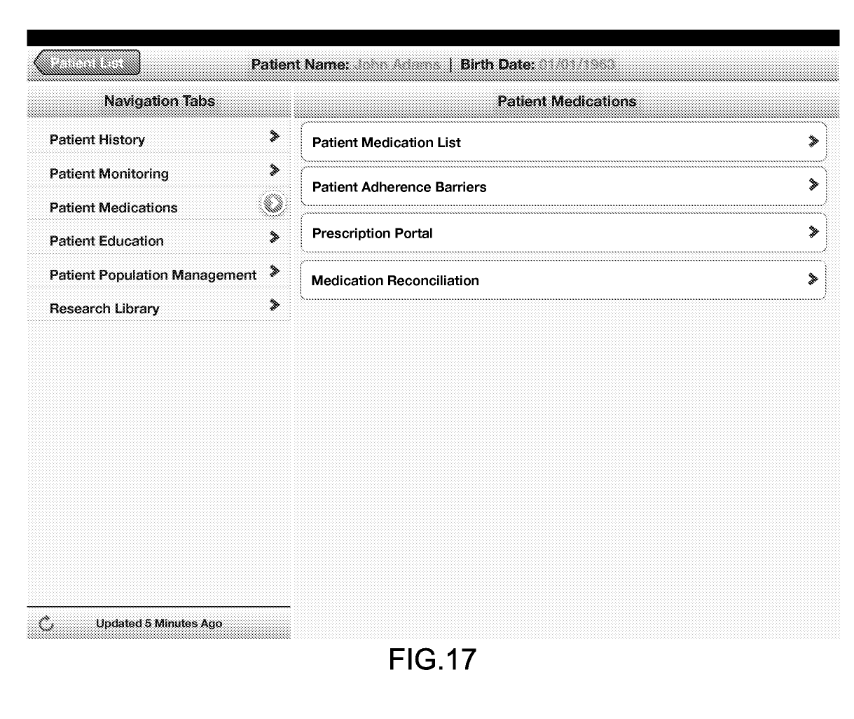

Returning to FIG. 12, in response to receiving input indicating selection of the patient medications navigation tab, the health care provider interface displays a patient medications screen as illustrated in FIG. 17.

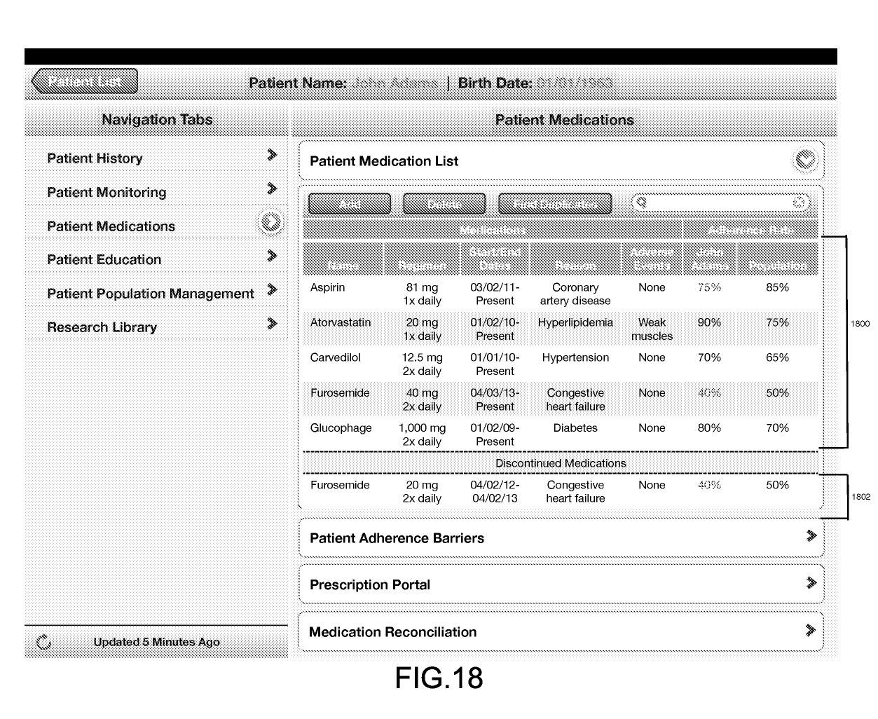

As illustrated in FIG. 17, the patient medications screen includes a link to a patient medication list associated with the selected patient identifier, a link to patient adherence barriers associated with the selected patient identifier, a link to a prescription portal associated with the selected patient identifier, and a link to medication reconciliation associated with the selected patient identifier. In response to receiving input indicating selection of the patient medication list link, the health care provider interface provides a patient medication list screen as illustrated in FIG. 18.

The medication information displayed by the patient medication list screen may include a variety of metrics stored within the patient data store 122 and displayed within various representations, such as graphs, tables, reports and other data presentation devices. Some of these metrics may be specific to one or more patients. Other metrics may be summaries calculated by an analytics engine 124 from information stored in the patient data store 122. As shown in FIG. 18, the patient medication list screen includes an active area 1800, an inactive area 1802, an add button, a delete button, a find duplicates button, and a search box. The medication information displayed by the patient medication list screen includes medication name, medication regimen that includes medication dose and frequency, medication start and end dates, medication reason, any adverse events associated with the medication, patient adherence rate and population adherence rate (e.g., U.S. population). Other embodiments may display additional or alternative medication information and the embodiments disclosed herein are not limited to a particular set of medication information.

In response to receiving input indicating selection of the add button, the health care provider interface provides user interface elements through which the health care provider interface receives input describing a new medication regimen. This input may include a medication name, a medication regimen that includes medication dose and frequency, medication start and end dates, medication reason, and any adverse events associated with the medication. In response to receiving and validating the input describing this new medication information, the health care provider interface stores the new medication information in the patient data store 122.

In response to receiving input indicating selection of the delete button, the health care provider interface moves one or more medications currently selected in the active area 1800 to the inactive area 1802 and records the end date in the patient data store 122. Also, in response to receiving input indicating selection of the delete button, the health care provider interface removes one or more medications currently selected in the inactive area 1802 from the patient medication list screen. In some embodiments, medications removed from the patient medication list screen are maintained in the patient data store 122 for purposes of future analysis.

In response to receiving input indicating selection of the find duplicates button, the health care provider interface locates and highlights any duplicate medications. In response to receiving input via the search box, the health care provider interface locates and highlights any medications matching the input.

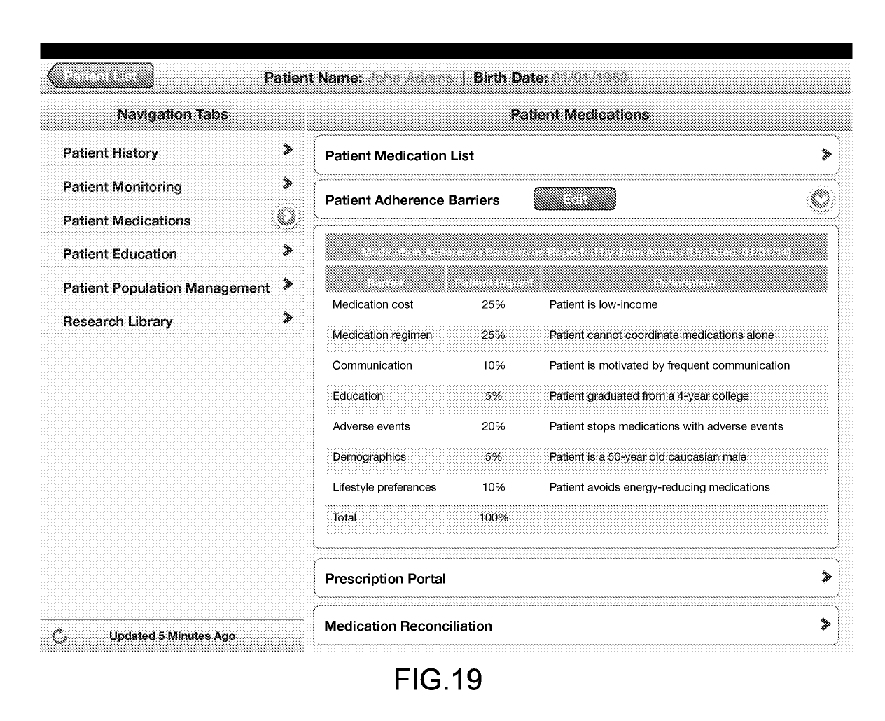

Returning to FIG. 17, in response to receiving input indicating selection of the patient adherence barriers link, the health care provider interface provides a patient adherence barriers screen as illustrated in FIG. 19.

As shown in FIG. 19, the patient adherence barriers screen includes an edit button and displays adherence barrier information associated with the selected patient identifier. This adherence barrier information includes types of adherence barriers, a percentage impact of the adherence barrier type, and a description of the adherence barrier type. In response to receiving input indicating selection of the edit button, the health care provider interface enables the fields displaying the adherence barrier information to receive input. In response to receiving input within the fields displaying the adherence barrier information, the health care provider interface stores the adherence barrier information in the patient data store 122. In some embodiments, the health care provider interface may request confirmation prior to storing the adherence bather information. Other embodiments may store and display additional or alternative adherence barrier information and the embodiments disclosed herein are not limited to a particular set of adherence barrier information.

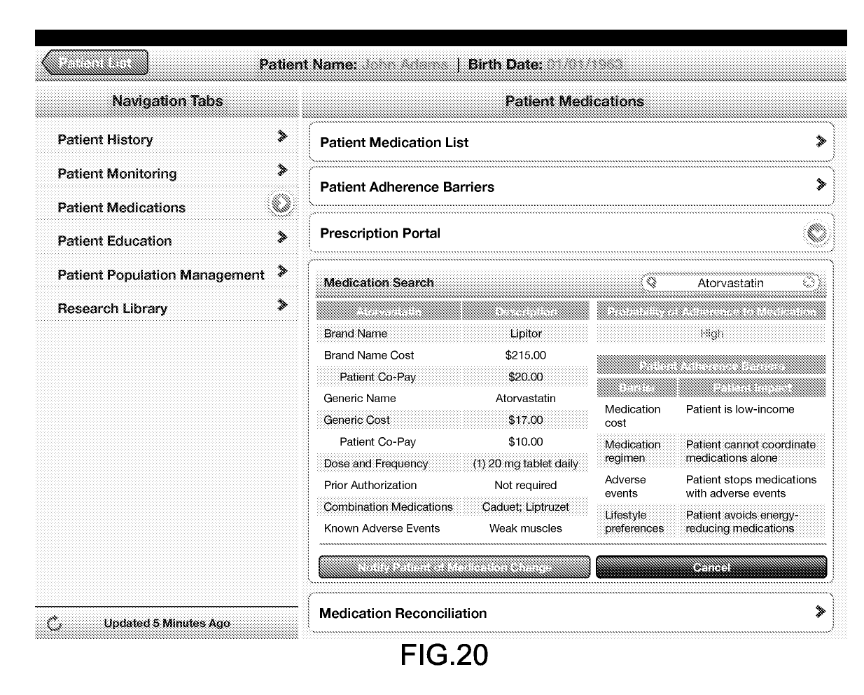

Returning to FIG. 17, in response to receiving input indicating selection of the prescription portal link, the health care provider interface provides a prescription portal screen as illustrated in FIG. 20.

As shown in FIG. 20, the prescription portal screen includes a search box, a notify patient of medication change button, and a cancel button. In response to receiving input via the search box, the health care provider interface locates and displays information for one or more medications matching the input. The medication information displayed by the prescription portal screen may include a variety of information of interest to the health care provider. As shown in FIG. 20, this medication information includes brand name, brand name cost, patient co-pay for the brand name, generic name, generic cost, patient co-pay for the generic, dose and frequency, prior authorization, combination medications, and known adverse events. The medication information also includes a probability of adherence to the medication associated with the selected patient identifier and a list of patient adherence barriers associated with the selected patient identifier and applicable to the selected medications. Other embodiments may display additional or alternative medication information and the embodiments disclosed herein are not limited to a particular set of medication information.

In response to receiving input indicating selection of the notify patient of medication change button, the health care provider interface generates and transmits a notification (e.g., an email, automated phone call, etc.) to the patient interface associated with the selected patient identifier or a contact point (e.g., email address) associated with the patient identifier in the patient data store. The notification may include information descriptive of the prescription or change in the prescription. In response to receiving input indicating selection of the cancel button, the health care provider interface makes no changes to the patient's medication regimen.

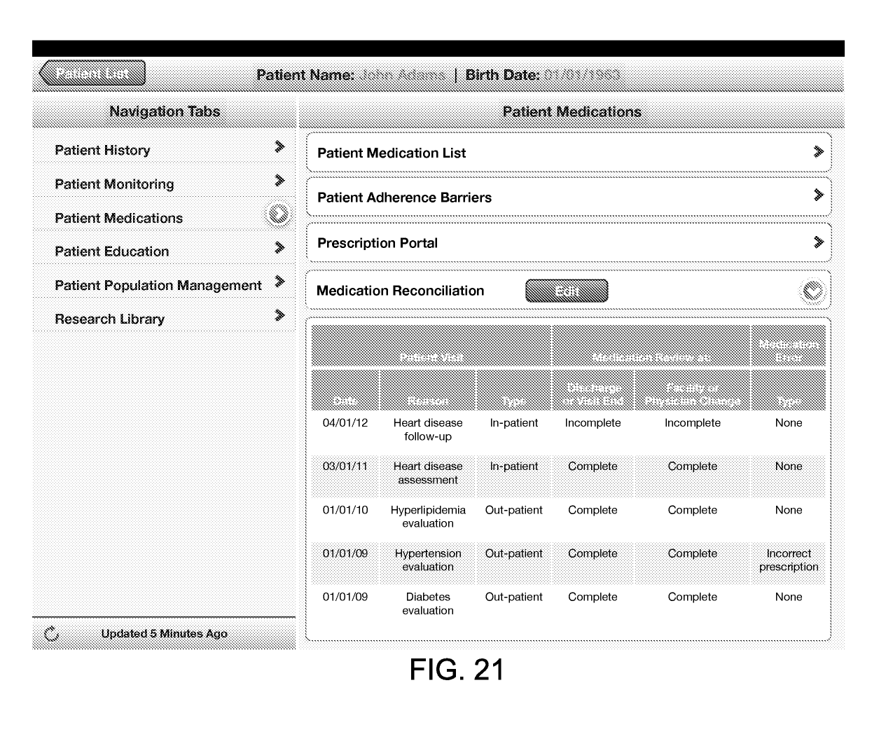

Returning to FIG. 17, in response to receiving input indicating selection of the medication reconciliation link, the health care provider interface provides a medication reconciliation screen as illustrated in FIG. 21.

As shown in FIG. 21, the medication reconciliation screen includes an edit button and displays medication reconciliation information associated with the selected patient identifier. This medication reconciliation information includes three categories: patient visit, medication review at a care transition stage, and medication error. The medication reconciliation information associated with the patient visit category includes descriptions of the date of the patient visit, the reason for the patient visit, and the type of patient visit (e.g., in-patient or out-patient). The medication reconciliation information associated with the medication review at a care transition stage category includes descriptions of whether the task of reviewing medications was completed upon care transitions (e.g., patient discharge, the end of the patient's visit, a change in medical facility, or a change in physician). The medication reconciliation information associated with the medication error category includes the types of medication errors discovered during the medication review. In response to receiving input indicating selection of the edit button, the health care provider interface enables the fields displaying the medication reconciliation information to receive input. In response to receiving input within the fields displaying the medication reconciliation information, the health care provider interface stores the medication reconciliation information in the patient data store 122. In some embodiments, the health care provider interface may request confirmation prior to storing the medication reconciliation information. Other embodiments may store and display additional or alternative medication reconciliation information and the embodiments disclosed herein are not limited to a particular set of medication reconciliation information.

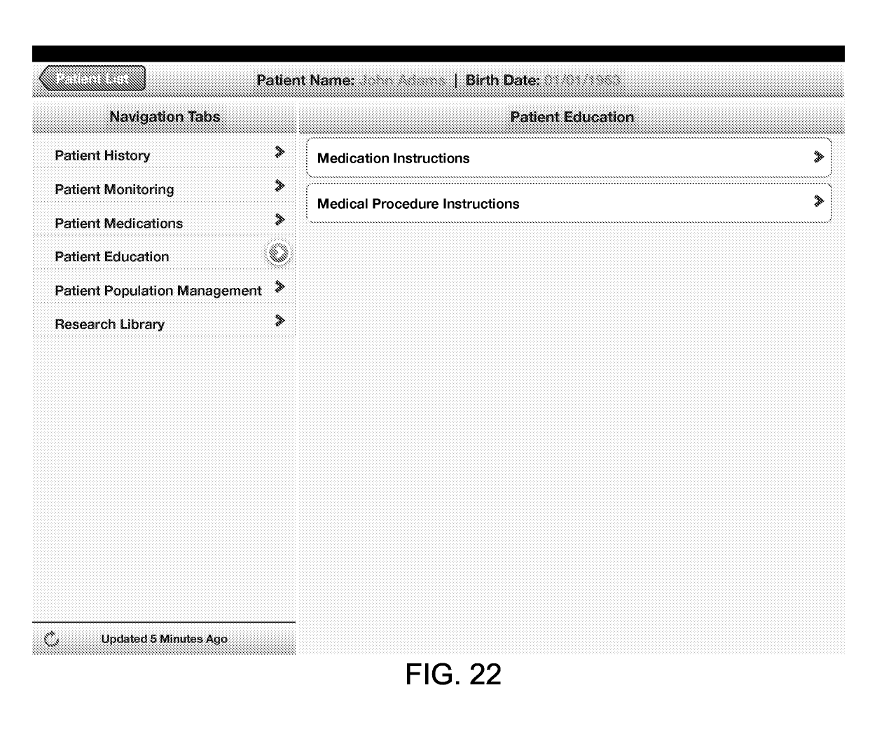

Returning to FIG. 17, in response to receiving input indicating selection of the patient education navigation tab, the health care provider interface displays a patient education screen as illustrated in FIG. 22.

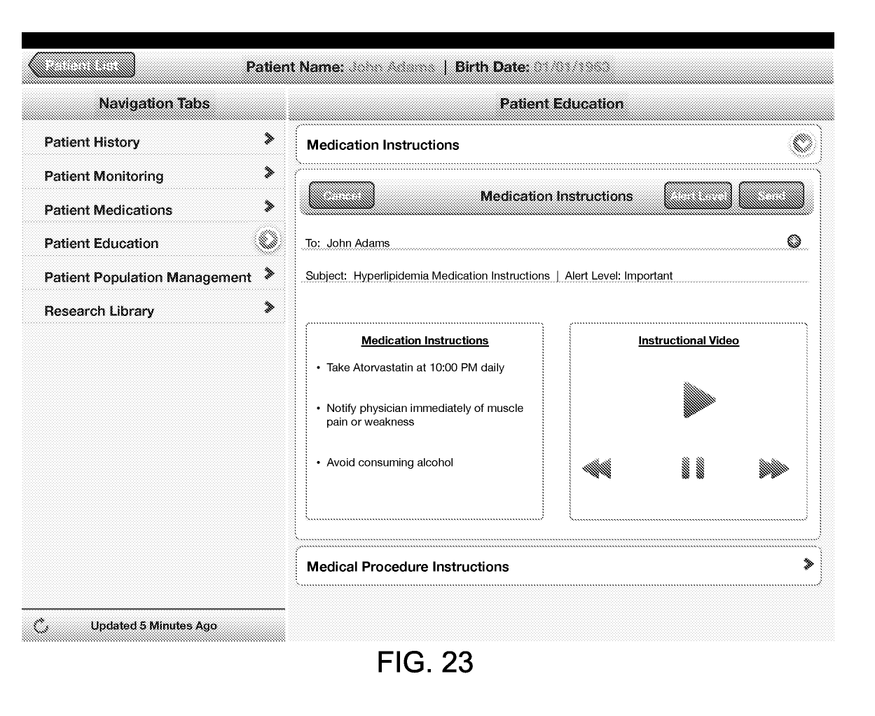

As illustrated in FIG. 22, the patient education screen includes a link to medication instructions associated with the selected patient identifier and a link to medical procedure instructions associated with the selected patient identifier. In response to receiving input indicating selection of the medication instructions link, the health care provider interface provides a medication instructions screen as illustrated in FIG. 23.

As shown in FIG. 23, the medication instructions screen includes a message area, a send button, an alert level button, and a cancel button. In an embodiment illustrated by FIG. 23, the health care provider interface is configured to receive input via the message area indicating one or more patients to whom a message is addressed, input indicating the subject of the message, and a body of the message. As shown in FIG. 23, the body of the message may include standardized (or customized) medication instructions and an instructional video. In response to receiving input indicating selection of the send button, the health care provider interface is configured to send the message to the patients to whom the message is addressed. In response to receiving input indicating selection of the alert level button, the health care provider interface is configured to indicate the alert level (e.g., important) as indicated by an alert level in the subject area of the message. In response to receiving input indicating selection of the cancel button, the health care provider interface is configured to reset the message area.

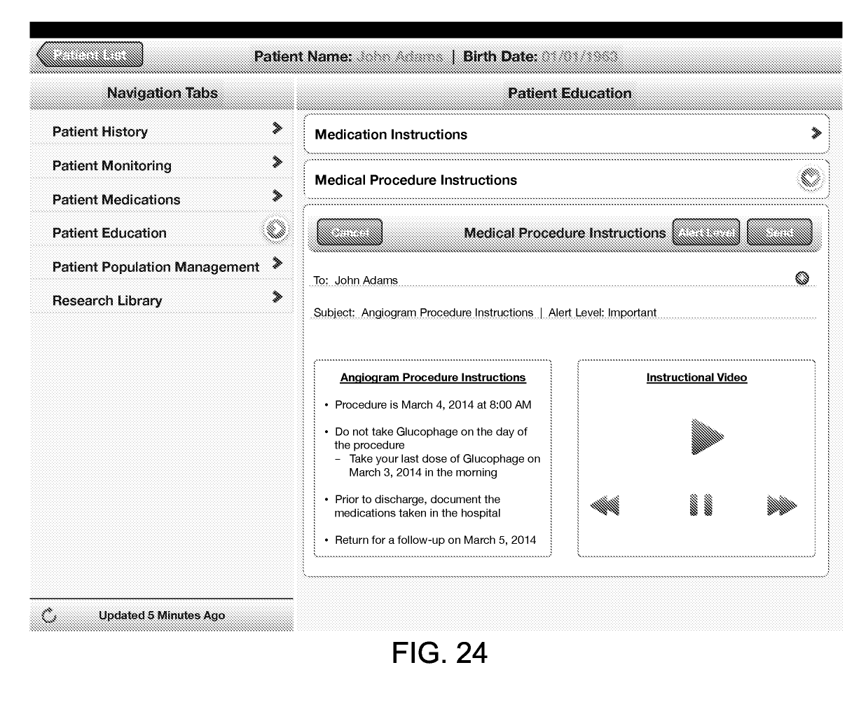

Returning to FIG. 22, in response to receiving input indicating selection of the medical procedure instructions link, the health care provider interface provides a medical procedure instructions screen as illustrated in FIG. 24.

As shown in FIG. 24, the medical procedure instructions screen includes a message area, a send button, an alert level button, and a cancel button. In an embodiment illustrated by FIG. 24, the health care provider interface is configured to receive input via the message area indicating one or more patients to whom a message is addressed, input indicating the subject of the message, and a body of the message. As shown in FIG. 24, the body of the message may include standardized (or customized) medical procedure instructions and an instructional video. In response to receiving input indicating selection of the send button, the health care provider interface is configured to send the message to the patients to whom the message is addressed. In response to receiving input indicating selection of the alert level button, the health care provider interface is configured to indicate the alert level (e.g., important) as indicated by an alert level in the subject area of the message. In response to receiving input indicating selection of the cancel button, the health care provider interface is configured to reset the message area.

Returning to FIG. 4, in response to receiving input indicating selection of the patient population management navigation tab, the health care provider interface displays a patient population management screen as illustrated in FIG. 25.

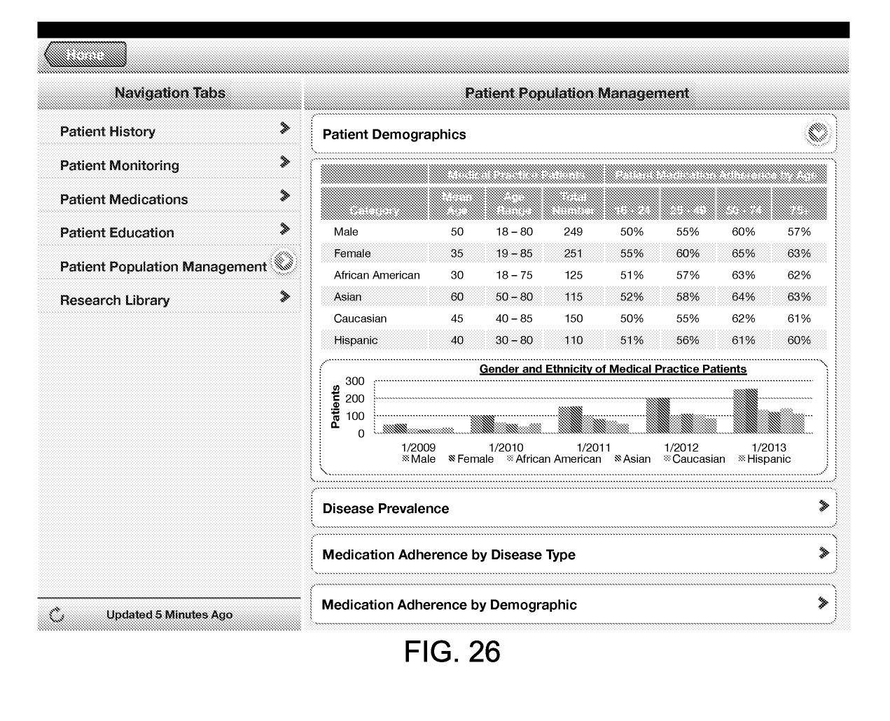

As illustrated in FIG. 25, the patient population management screen includes a link to patient demographics information associated with a population of patients, a link to disease prevalence information associated with a population of patients, a link to medication adherence by disease type information associated with a population of patients, and a link to medication adherence by demographic information associated with a population of patients. In response to receiving input indicating selection of the patient demographics link, the health care provider interface provides a patient demographics screen as illustrated in FIG. 26.

The patient demographics information displayed by the patient demographics screen may include a variety of metrics stored within the patient data store 122 and displayed within various representations, such as graphs, tables, reports and other data presentation devices. Some of these metrics may be specific to one or more patients. Other metrics may be summaries calculated by the analytics engine 124 from information stored in the patient data store 122. As shown in FIG. 26, the patient demographics information displayed by the patient demographics screen includes a table listing demographic categories, a mean age for each demographic category, an age range for each demographic category, a total number of patients within the health care provider's practice population who belong to each demographic category, and a patient medication adherence by age range within each demographic category. The patient demographics information displayed by the patient demographics screen also includes a bar chart illustrating a number of patients of the health care provider or the health care provider's medical practice by demographic group over time. Other embodiments may store and display additional or alternative patient demographics information and the embodiments disclosed herein are not limited to a particular set of patient demographics information.

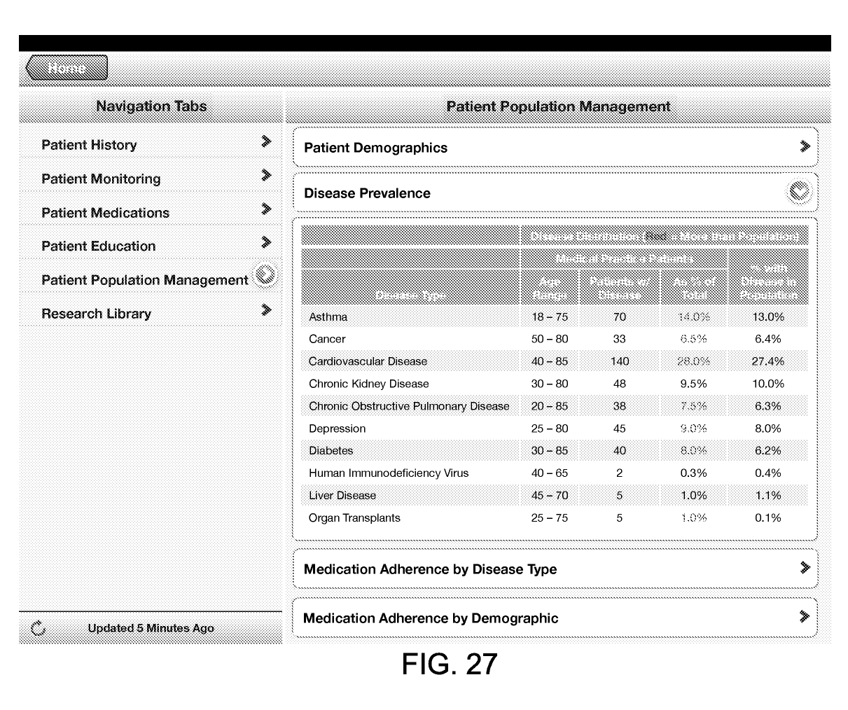

Returning to FIG. 25, in response to receiving input indicating selection of the disease prevalence link, the health care provider interface provides a disease prevalence screen as illustrated in FIG. 27.

The disease prevalence information displayed by the disease prevalence screen may include a variety of metrics stored within the patient data store 122 and displayed within various representations, such as graphs, tables, reports and other data presentation devices. Some of these metrics may be specific to one or more patients. Other metrics may be summaries calculated by the analytics engine 124 from information stored in the patient data store 122. As shown in FIG. 27, the disease prevalence information displayed by the disease prevalence screen includes a table listing disease types, a range of ages of patients of the health care provider's medical practice associated with each disease type, a number of patients of the health care provider's medical practice associated with each disease type, a percentage of a total number of patients of the health care provider's medical practice associated with each disease type, and a percentage of a total population (e.g., U.S. population) associated with each disease type. A typographical indicator (e.g., a color) identifies when disease prevalence information associated with the health care provider or the health care provider's medical practice is more or less than that of the population identified in the disease prevalence screen. Other embodiments may store and display additional or alternative disease prevalence information and the embodiments disclosed herein are not limited to a particular set of disease prevalence information.

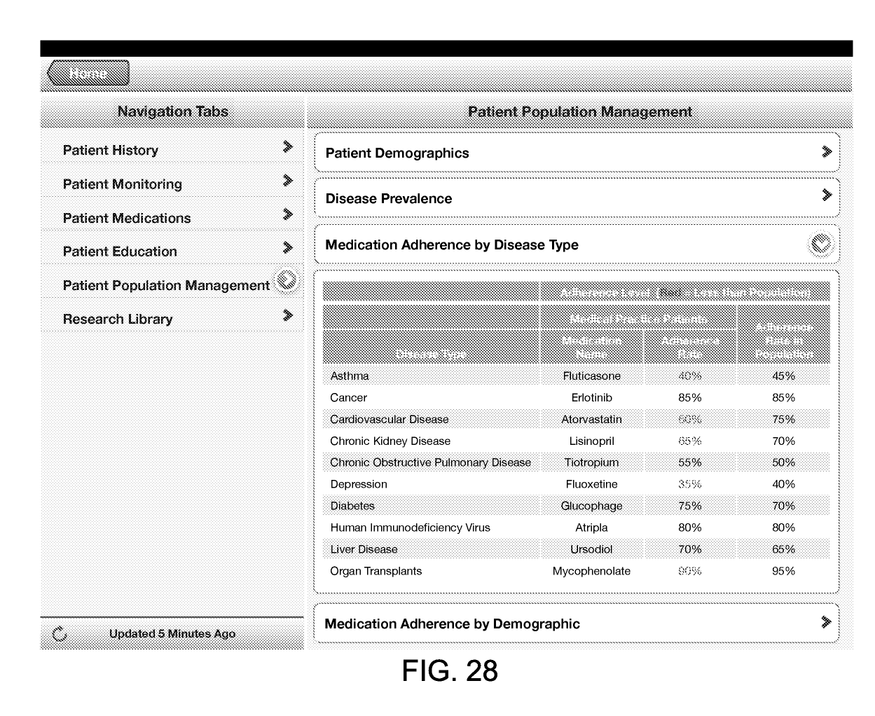

Returning to FIG. 25, in response to receiving input indicating selection of the medication adherence by disease type link, the health care provider interface provides a medication adherence by disease type screen as illustrated in FIG. 28.

The medication adherence by disease type information displayed by the medication adherence by disease type screen may include a variety of metrics stored within the patient data store 122 and displayed within various representations, such as graphs, tables, reports and other data presentation devices. Some of these metrics may be specific to one or more patients. Other metrics may be summaries calculated by the analytics engine 124 from information stored in the patient data store 122. As shown in FIG. 28, the medication adherence by disease type information displayed by the medication adherence by disease type screen includes a table listing disease types, medication prescribed by the health care provider or the health care provider's medical practice to treat each disease type or medications that are commonly prescribed or recommended to be prescribed to treat each given disease, a percentage adherence rate of patients of the health care provider or the health care provider's medical practice by disease type, and a percentage adherence rate of a total population (e.g., U.S. population) by disease type. A typographical indicator (e.g., a color) identifies when medication adherence by disease type information associated with the health care provider or the health care provider's medical practice is more or less than that of the population identified in the medication adherence by disease type information screen. Other embodiments may store and display additional or alternative medication adherence by disease type information and the embodiments disclosed herein are not limited to a particular set of medication adherence by disease type information.

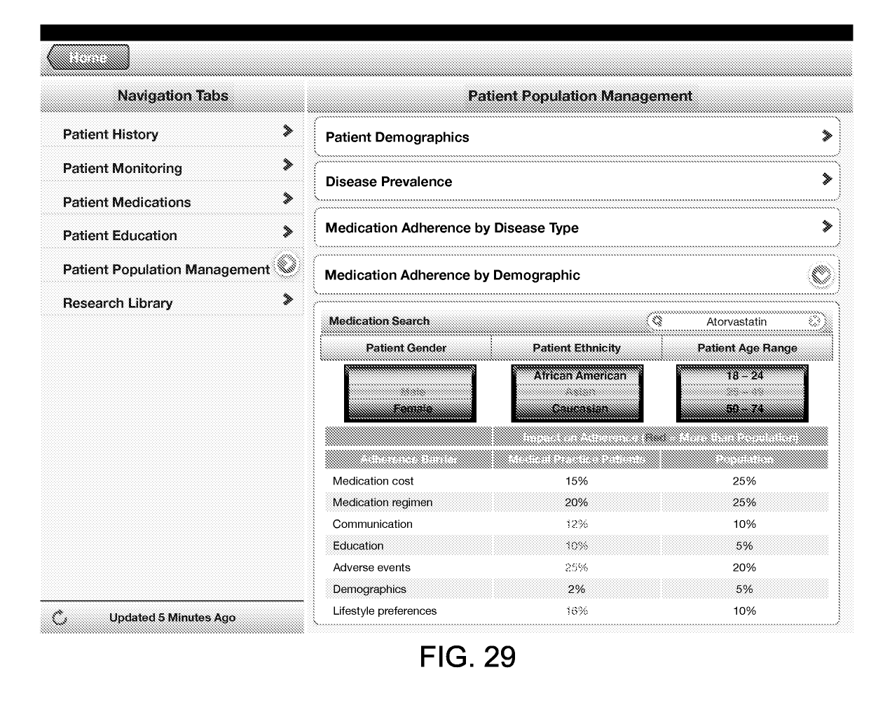

Returning to FIG. 25, in response to receiving input indicating selection of the medication adherence by demographic link, the health care provider interface provides a medication adherence by demographic screen as illustrated in FIG. 29.

The medication adherence by demographic information displayed by the medication adherence by demographic screen may include a variety of metrics stored within the patient data store 122 and displayed within various representations, such as graphs, tables, reports and other data presentation devices. Some of these metrics may be specific to one or more patients. Other metrics may be summaries calculated by the analytics engine 124 from information stored in the patient data store 122. As shown in FIG. 29, the medication adherence by demographic information displayed by the medication adherence by demographic information screen includes a medication search area including a search box and scroll menus enabling selection of patient gender information, patient ethnicity information, and patient age range information. The medication adherence by demographic screen also displays a table listing adherence barriers, the impact of each adherence barrier on patients associated with the health care provider or the health care provider's medical practice, and the impact of each adherence barrier on a total population (e.g., U.S. population).

As illustrated in FIG. 29, in response to receiving input via the search box, the health care provider interface locates and displays information for one or more medications matching the input. Further, in response to receiving input via the scroll menus enabling selection of patient gender information, patient ethnicity information, and patient age range information, the health care provider interface displays the impact, in the form of a percentage, that each adherence barrier has on adherence to medication for the selected medication and the selected demographic group. A typographical indicator (e.g., a color) identifies when the impact of the adherence barrier on patients associated with the health care provider or the health care provider's medical practice is more or less than that of the population (e.g., U.S. population) identified in the medication adherence by demographic information screen. Other embodiments may store and display additional or alternative medication adherence by demographic information and the embodiments disclosed herein are not limited to a particular set of medication adherence by demographic information.

Returning to FIG. 4, in response to receiving input indicating selection of the research library navigation tab, the health care provider interface displays a research library screen as illustrated in FIG. 30.

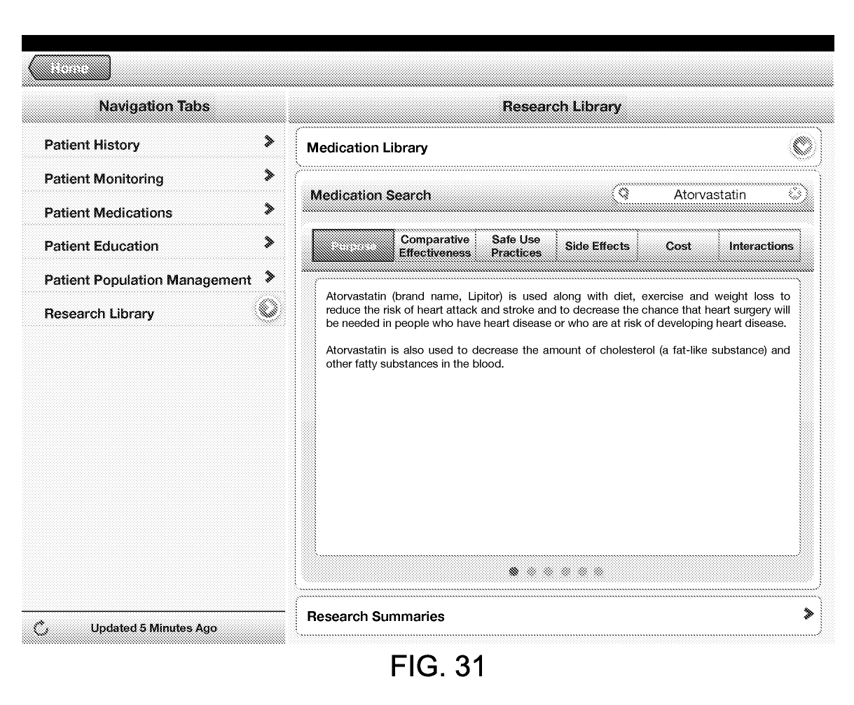

As illustrated in FIG. 30, the research library screen includes a link to a medication library and a link to research summaries. In response to receiving input indicating selection of the medication library link, the health care provider interface provides a medication library screen as illustrated in FIG. 31.

As shown in FIG. 31, the medication library screen includes a search box. In response to receiving input via the search box, the health care provider interface locates and displays information for one or more medications matching the input. The medication information displayed by the medication library screen may include a variety of information of interest to the health care provider. As shown in FIG. 31, this medication information includes its purpose, comparative effectiveness, safe use practices, side effects, cost, and interactions. Other embodiments may display additional or alternative medication information and the embodiments disclosed herein are not limited to a particular set of medication information.

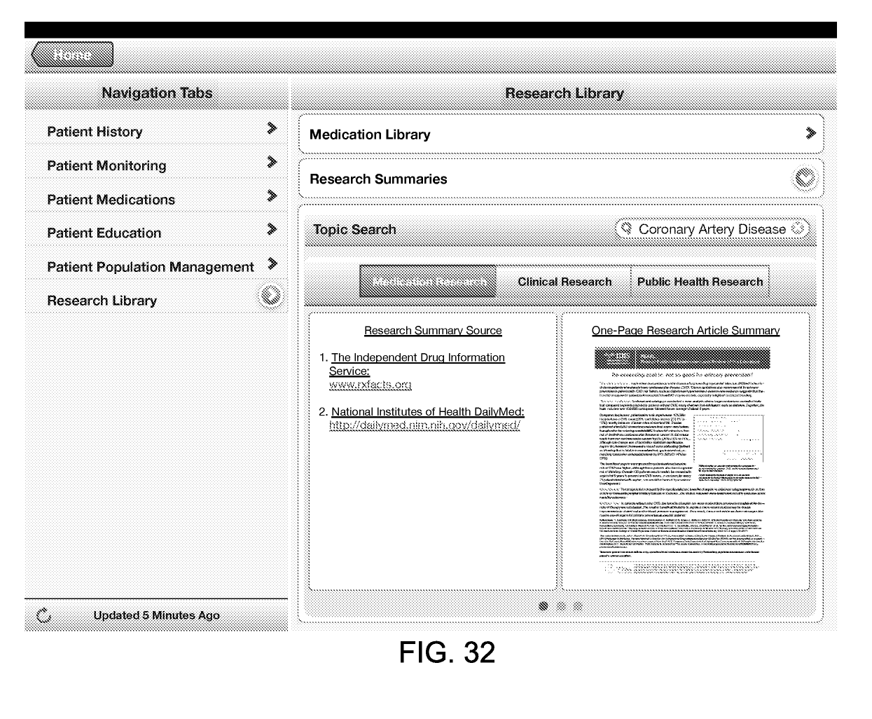

Returning to FIG. 30, in response to receiving input indicating selection of the research summaries link, the health care provider interface provides a research summaries screen as illustrated in FIG. 32.

As shown in FIG. 32, the research summaries screen includes a search box. In response to receiving input via the search box, the health care provider interface locates and displays information for one or more research topics matching the input. The research topic information displayed by the research summaries screen may include a variety of information of interest to the health care provider. As shown in FIG. 32, this research topic information includes medication research, clinical research, and public health research. Other embodiments may display additional or alternative research topic information and the embodiments disclosed herein are not limited to a particular set of research topic information.

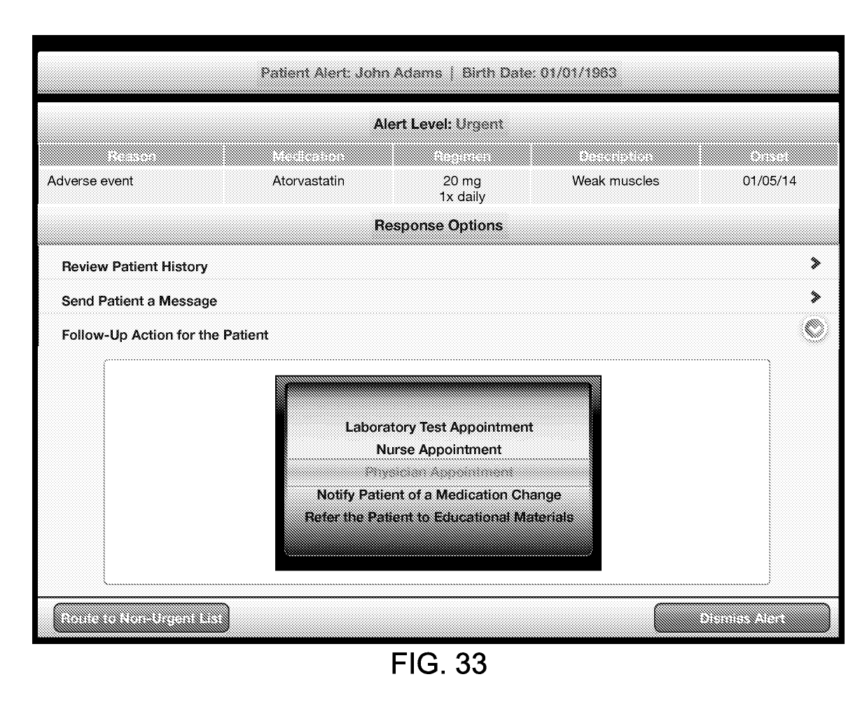

FIG. 33 illustrates an alert screen provided by the health care provider interface. As shown in FIG. 33, the alert screen includes information identifying the patient associated with the alert, alert information, and response options. The information identifying the patient may include the patient's name and date of birth. The alert information may include an alert level (e.g., urgent or non-urgent), reason for the alert, medication associated with the alert, regimen including dose and frequency of the medication, description of the alert, and a date and time of the onset of the event causing the alert (e.g., an adverse event). The response options include a link to review the history of the patient, a link to a message screen to send the patient a message, a control to enable the health care provider to notify the patient of a follow-up action associated with the alert, a route to non-urgent list button and a dismiss alert button. In response to receiving input indicating selection of the route to non-urgent list button, the health care provider interface changes the type of the alert being reported from urgent to non-urgent. In response to receiving input indicating selection of the dismiss alert button, the health care provider interface removes the alert from the health care provider's queue. Other embodiments may display additional or alternative alert-related information and the embodiments disclosed herein are not limited to a particular set of alert-related information.

Various embodiments disclosed herein implement a patient interface, such as the patient interface 126 described above with reference to FIG. 1, through which a medication manager component, such as the medication manager component described above with reference to FIG. 1, receives and processes patient information requests. In some embodiments, the patient interface exchanges information with a patient, such as the patient 102 described above with reference to FIG. 1, via a computer system that is associated with the patient, such as the computer system 108 described above with reference to FIG. 1.

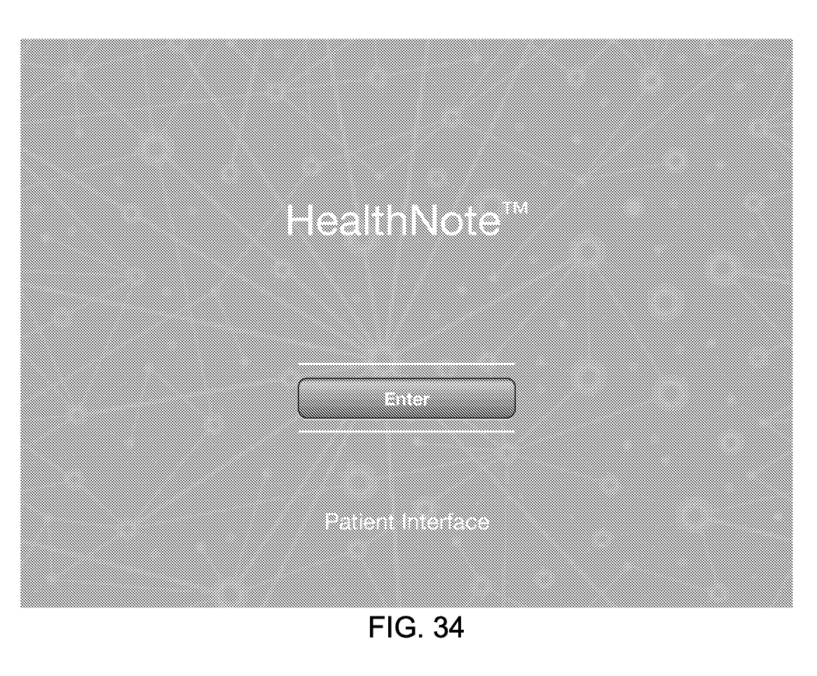

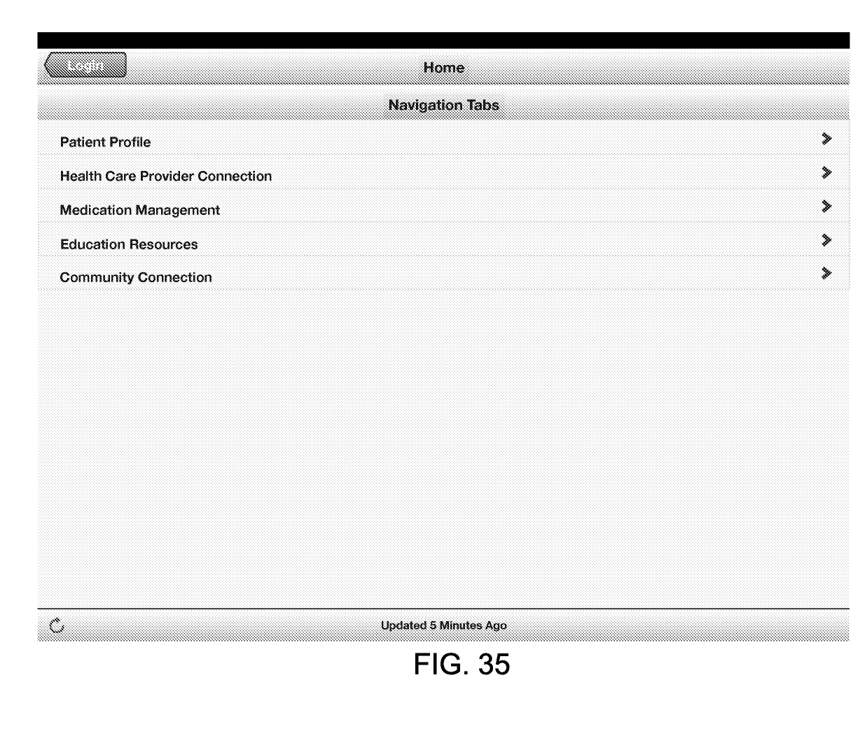

FIG. 34 illustrates a login screen provided by the patient interface. As shown in FIG. 34, the login screen includes an enter button. In response to receiving input indicating selection of the enter button, the patient interface requests authentication credentials. If the patient interface does not receive authentication credentials associated with a configured patient account within a predetermined timeframe, the patient interface denies entry to other screens. Otherwise, the patient interface provides a home screen as illustrated in FIG. 35.

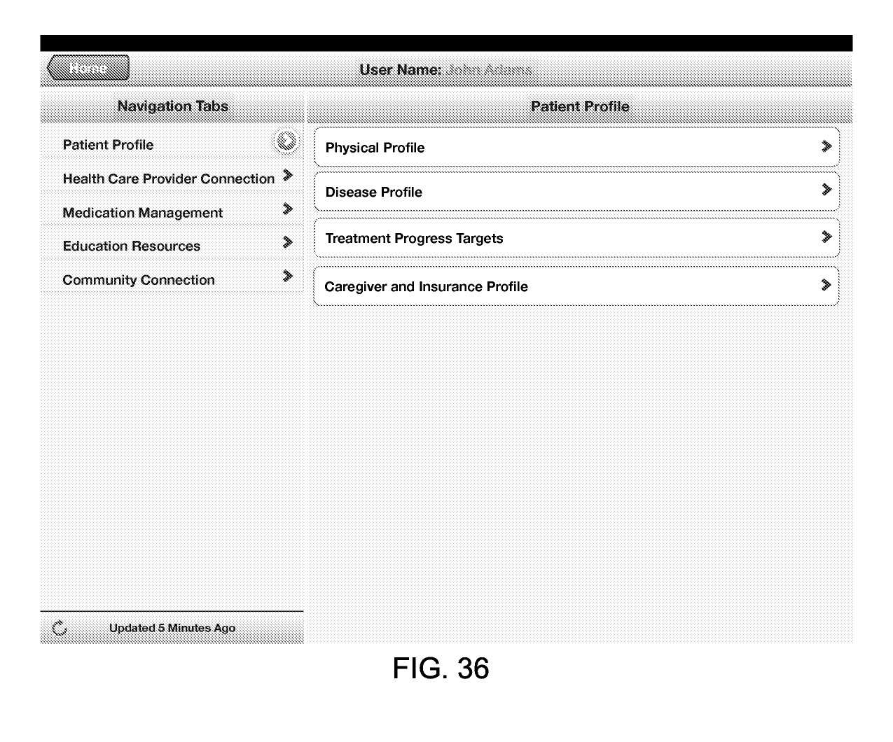

As shown in FIG. 35, the home screen includes the following navigation tabs: patient profile, health care provider connection, medication management, education resources, and community connection, as do the screens illustrated in FIGS. 36-55. In response to receiving input indicating selection of the patient profile tab, the patient interface provides a patient profile screen as illustrated in FIG. 36.

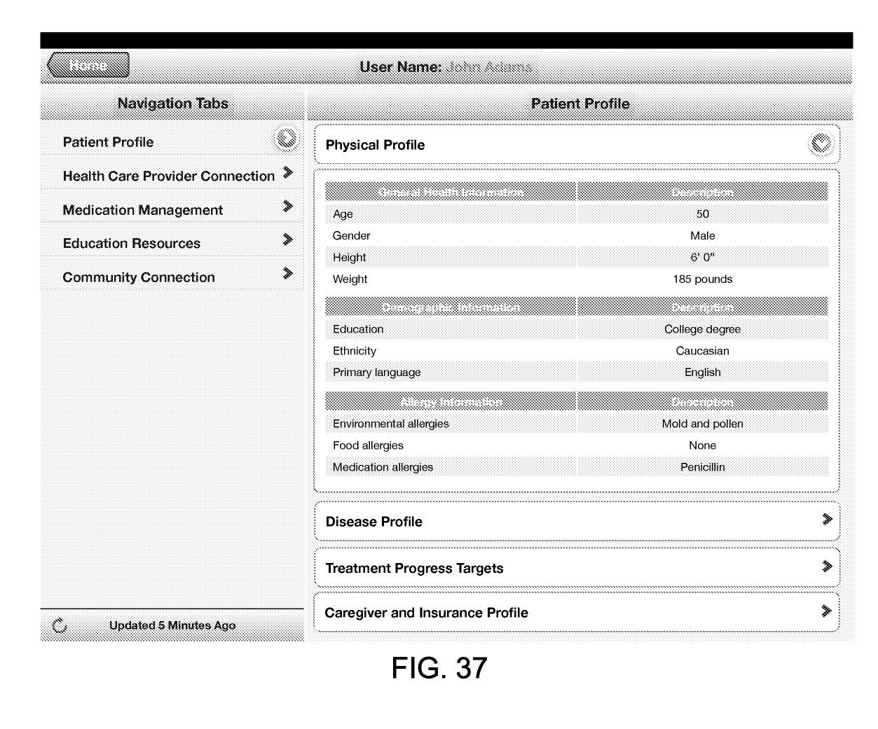

As shown in FIG. 36, the patient profile screen displays the name of the patient corresponding to the authentication credentials, as do the screens illustrated in FIGS. 37-55. The patient profile screen also includes a link to a physical profile associated with the patient, a link to a disease profile associated with the patient, a link to treatment progress targets associated with the patient, and a link to a caregiver and insurance profile associated with the patient. In response to receiving input indicating selection of the physical profile link, the patient interface provides a physical profile screen as illustrated in FIG. 37.

As shown in FIG. 37, the physical profile screen displays general health information, demographic information, and allergy information associated with the patient. The general health information displayed by the physical profile screen includes age, gender, height, and weight. The demographic information includes education, ethnicity, and primary language. The allergy information includes environmental allergies, food allergies, and medication allergies. Other embodiments may store and display additional or alternative physical profile information and the embodiments disclosed herein are not limited to a particular set of physical profile information.

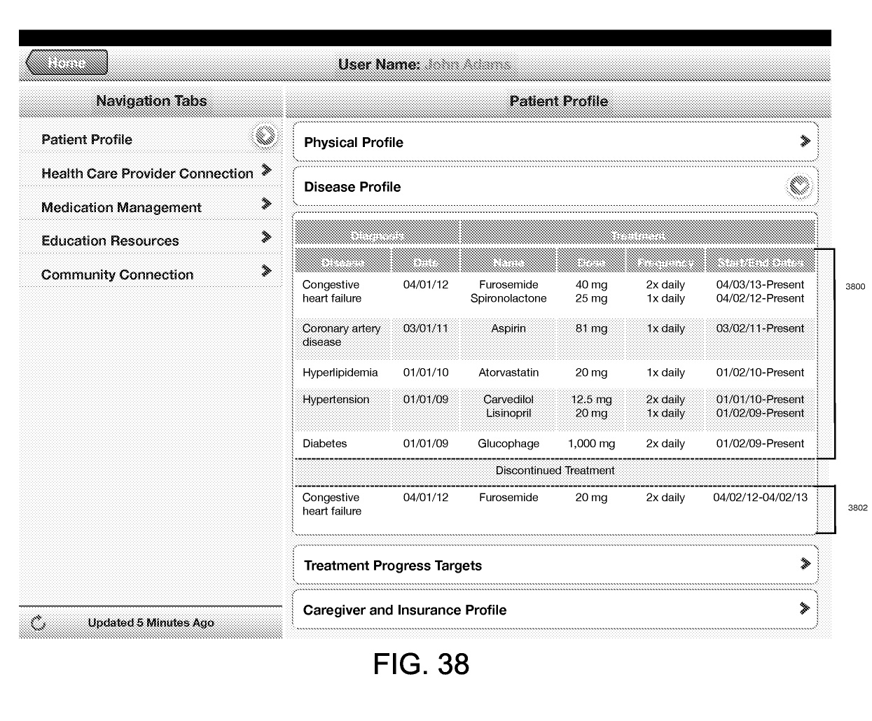

Returning to FIG. 36, in response to receiving input indicating selection of the disease profile link, the patient interface provides a disease profile screen as illustrated in FIG. 38.

As shown in FIG. 38, the disease profile screen displays disease diagnosis and treatment information associated with the patient. The disease profile screen includes an active area 3800 and an inactive area 3802. The disease diagnosis and treatment information displayed by the disease profile screen includes previously diagnosed diseases, dates of the diagnosis, medications prescribed, dosages, dosage frequencies, dates that medication dosages were initiated, and dates that medication dosages were terminated. Other embodiments may store and display additional or alternative disease profile information and the embodiments disclosed herein are not limited to a particular set of disease profile information.

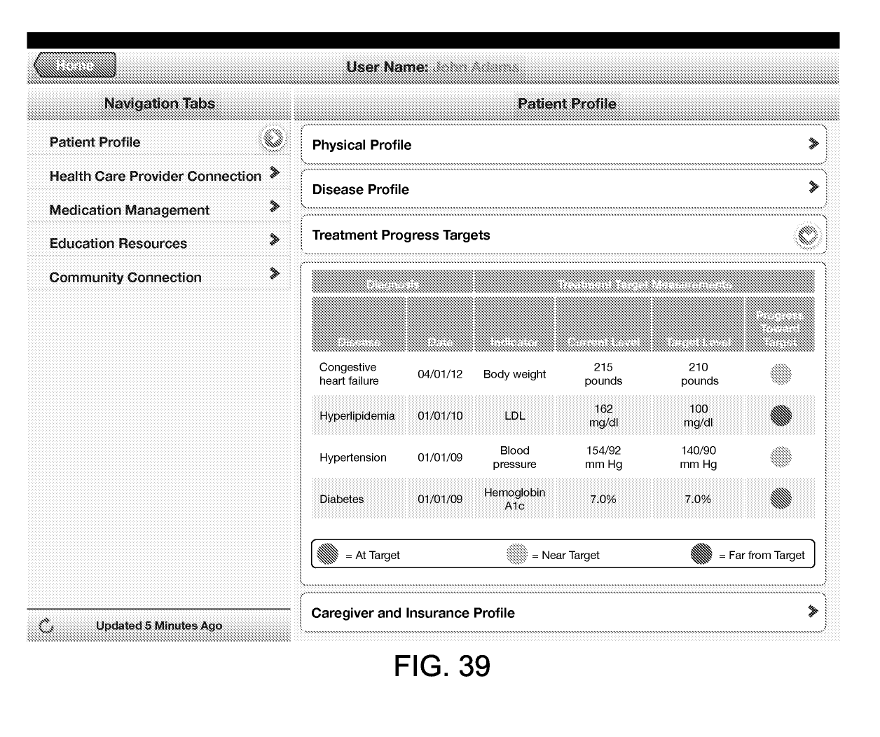

Returning to FIG. 36, in response to receiving input indicating selection of the treatment progress targets link, the patient interface provides a treatment progress targets screen as illustrated in FIG. 39.

As shown in FIG. 39, the treatment progress targets screen displays diagnosis and treatment target measurements information associated with the patient. The diagnosis and treatment target measurements information displays previously diagnosed diseases, dates of the diagnosis, biological or non-biological indicators of treatment progress associated with a diagnosis, current levels of biological or non-biological indicators of treatment progress associated with a diagnosis, target levels of biological or non-biological indicators of treatment progress associated with a diagnosis, and progress toward achievement of a target. The progress toward target measurements is indicated by typographical indicator (e.g., a color), as illustrated by the color-coded indicators in the key at the bottom portion of the screen whereby green indicates at target, yellow indicates near target, and red indicates far from target. Other embodiments may store and display additional or alternative treatment progress targets information and the embodiments disclosed herein are not limited to a particular set of treatment progress targets information.

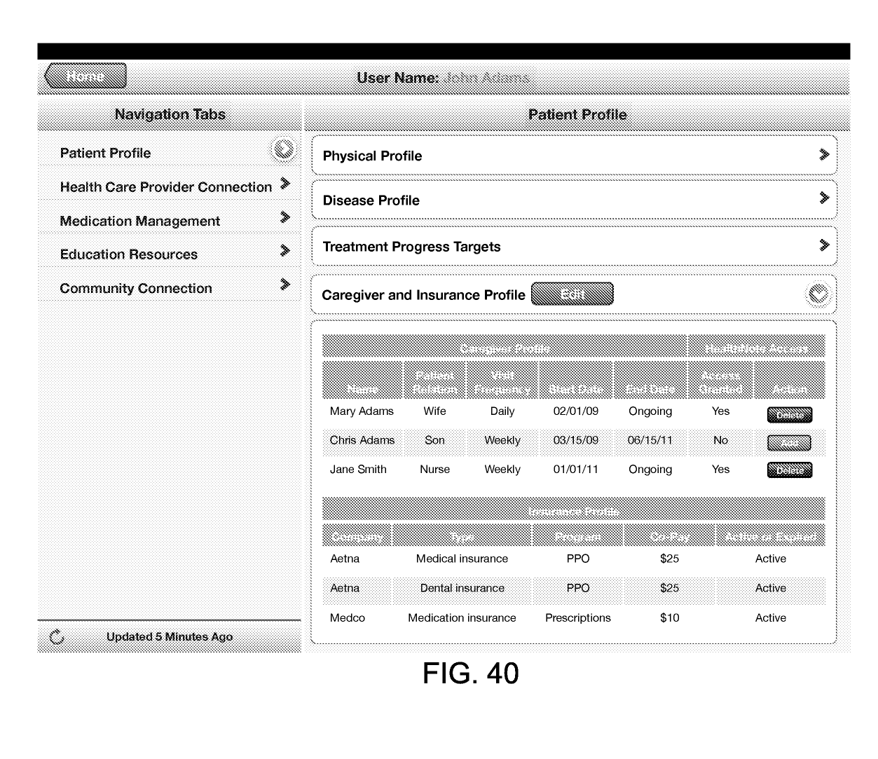

Returning to FIG. 36, in response to receiving input indicating selection of the caregiver and insurance profile link, the patient interface provides a caregiver and insurance profile screen as illustrated in FIG. 40.

As shown in FIG. 40, the caregiver and insurance profile screen includes an edit button and displays caregiver information and insurance information associated with the patient. In response to receiving input indicating selection of the edit button, the patient interface enables the fields displaying the caregiver information and the insurance information to receive input. In response to receiving input within the fields displaying the caregiver information and the insurance information, the patient interface stores the caregiver information and the insurance information in the patient data store. In some embodiments, the patient interface may request confirmation prior to storing the caregiver information and the insurance information.

As shown in FIG. 40, the caregiver information displayed by the caregiver and insurance profile screen includes names of the caregivers, relations of the caregivers to the patient, the frequency with which care is provided, dates upon which giving of care was initiated, and dates upon which giving of care was terminated. The caregiver information also includes an access area that indicates whether a caregiver has been granted access to the patient interface associated with the patient. Further, the access area within the caregiver information includes an add button and a delete button. In response to receiving input indicating selection of the add button, the patient interface initiates the process of establishing a user account for the caregiver which the caregiver accesses through the patient interface. In response to receiving input including the requested caregiver account information, the patient interface creates an account for the caregiver and transmits a notification of the account setup process to the email address included in the caregiver account information. The notification may include a link to a login screen of a patient interface, such as the patient interface 126 described above with reference to FIG. 1. In response to receiving input indicating selection of the delete button, the patient interface removes one or more caregivers selected in the caregiver profile information and from the patient data store 122 described above with reference to FIG. 1.

The insurance information includes insurer, type of insurance, insurance program, co-pay amount, and whether the insurance is active or expired. Other embodiments may store and display additional or alternative caregiver and insurance profile information and the embodiments disclosed herein are not limited to a particular set of caregiver and insurance profile information.

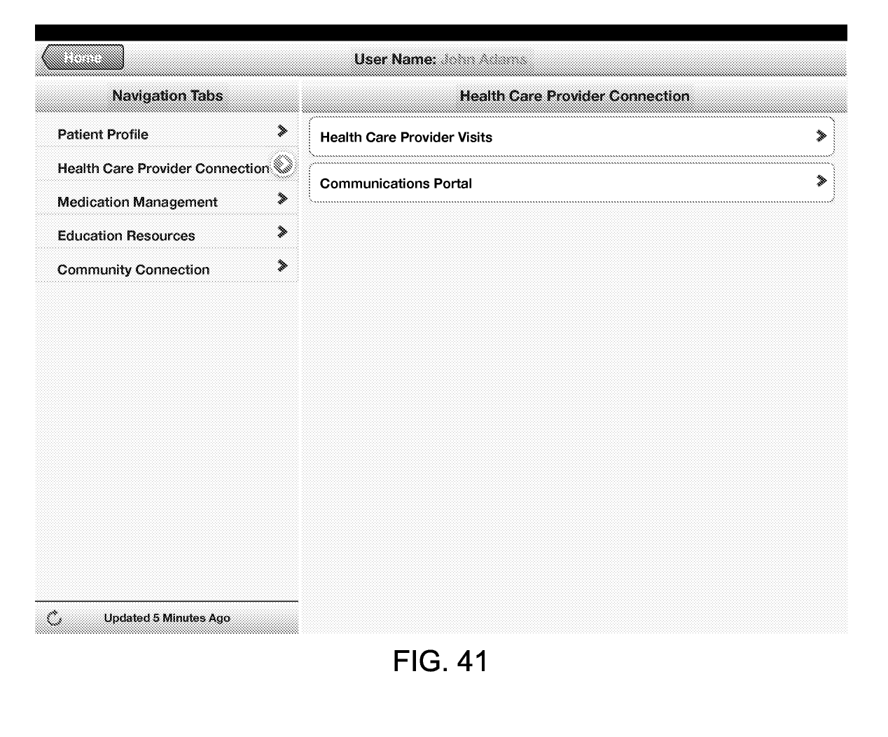

Returning to FIG. 35, in response to receiving input indicating selection of the health care provider connection navigation tab, the patient interface displays a health care provider connection screen as illustrated in FIG. 41.

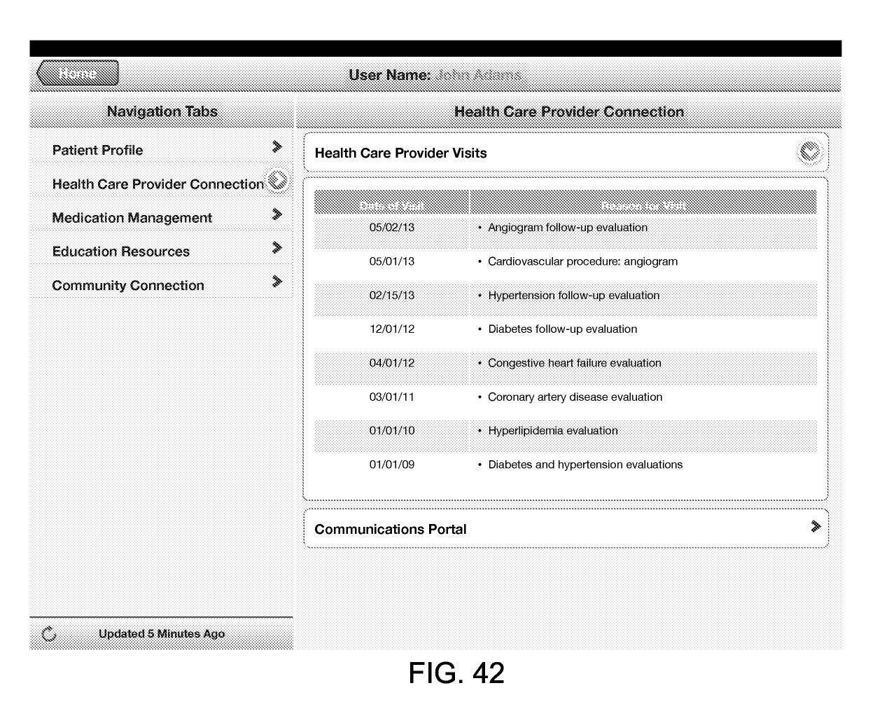

As illustrated in FIG. 41, the health care provider connection screen includes a link to health care provider visits associated with the patient and a link to a communications portal. In response to receiving input indicating selection of the health care provider visits link, the patient interface provides a health care provider visits screen as illustrated in FIG. 42.

As shown in FIG. 42, the health care provider visits information displayed by the health care provider visits screen includes a table that lists the dates and reasons for patient visits to the health care provider. Other embodiments may display additional or alternative health care provider visits information and the embodiments disclosed herein are not limited to a particular set of health care provider visits information.

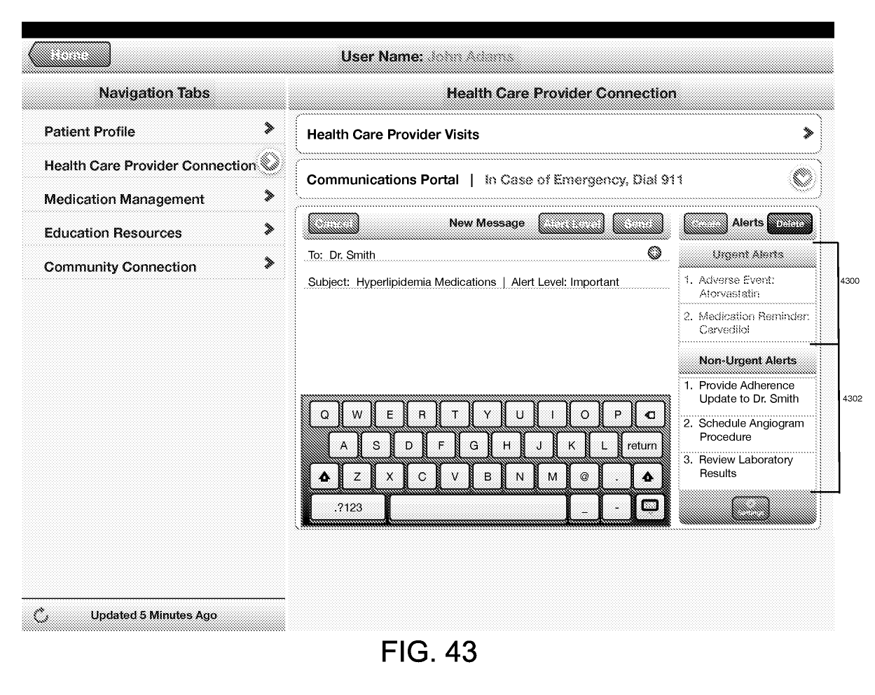

Returning to FIG. 41, in response to receiving input indicating selection of the communications portal link, the patient interface provides a communications portal screen as illustrated in FIG. 43.

As shown in FIG. 43, the communications portal screen includes a message area 4300 and an alert area 4302. The message area 4300 includes a virtual keyboard, a new message area, a send button, an alert level button, and a cancel button. The alert area 4302 includes an urgent alerts section and a non-urgent alerts section. The alert area 4302 also includes a create button, a delete button, and a settings button.

In an embodiment illustrated by FIG. 43, the patient interface is configured to receive input via the new message area indicating one or more health care providers to whom a message is addressed, input indicating the subject of the message, and a body of the message via the virtual keyboard. In response to receiving input indicating selection of the send button, the patient interface is configured to send the message to the health care providers to whom the message is addressed. In response to receiving input indicating selection of the alert level button, the patient interface is configured to indicate the alert level (e.g., important) as indicated by an alert level in the subject area of the message. In response to receiving input indicating selection of the cancel button, the patient interface is configured to reset the new message area. In some embodiments, this screen may also include a pull-down or scroll menu that enables patients to select and send a pre-formatted message or response to the health care provider. When a pre-formatted message or response is selected, the patient interface automatically populates the title and content of the message being sent to the health care provider without requiring additional typing on the virtual keyboard.

In another embodiment illustrated by FIG. 43, the patient interface is configured to display current and past urgent and non-urgent alerts in the alerts area 4302. In response to receiving input indicating selection of the create button, the patient interface provides a set of interface elements through which the patient interface receives input descriptive of an alert. The information descriptive of an alert may include an alert type (e.g., urgent or non-urgent), one or more users to whom the alert is addressed, and an alert message. Example alert messages include messages descriptive of adverse events, medication reminders, adherence updates, procedure reminders, and reminders to review laboratory results. In response to receiving input indicating selection of the delete button, the patient interface deletes an alert currently selected in alerts area 4302 from the system. In response to receiving input indicating selection of the settings button, the patient interface displays one or more additional user interface elements through which the patient interface can receive input selecting the channel through which, and frequency with which, each classification of alert is transmitted to the patient (such as through audible, visual, electronic message or other means). Other embodiments may display additional or alternative message or alert information and the embodiments disclosed herein are not limited to a particular set of message or alert information.

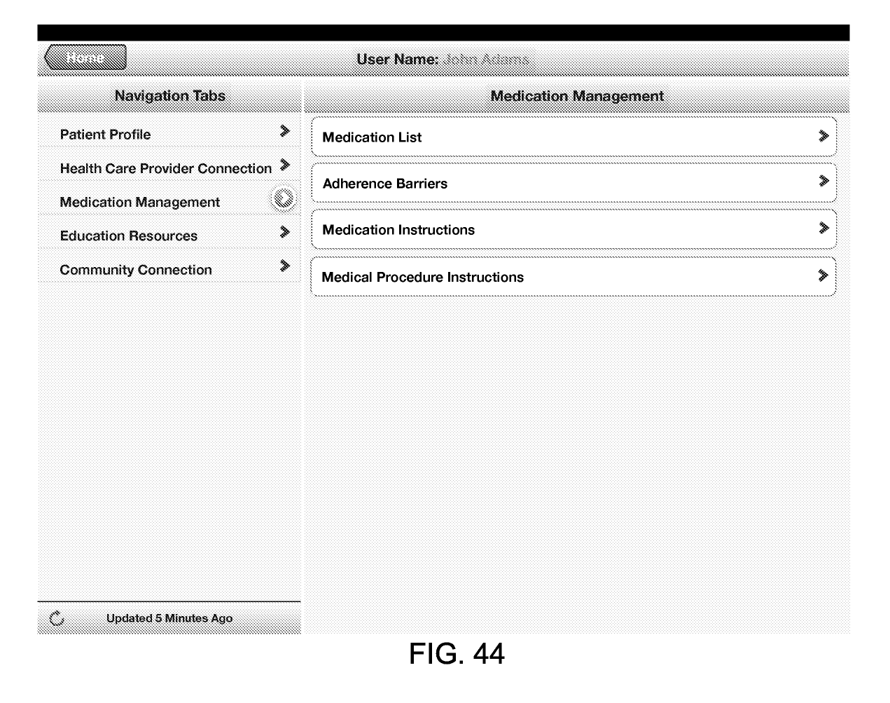

Returning to FIG. 35, in response to receiving input indicating selection of the medication management navigation tab, the patient interface displays a medication management screen as illustrated in FIG. 44.

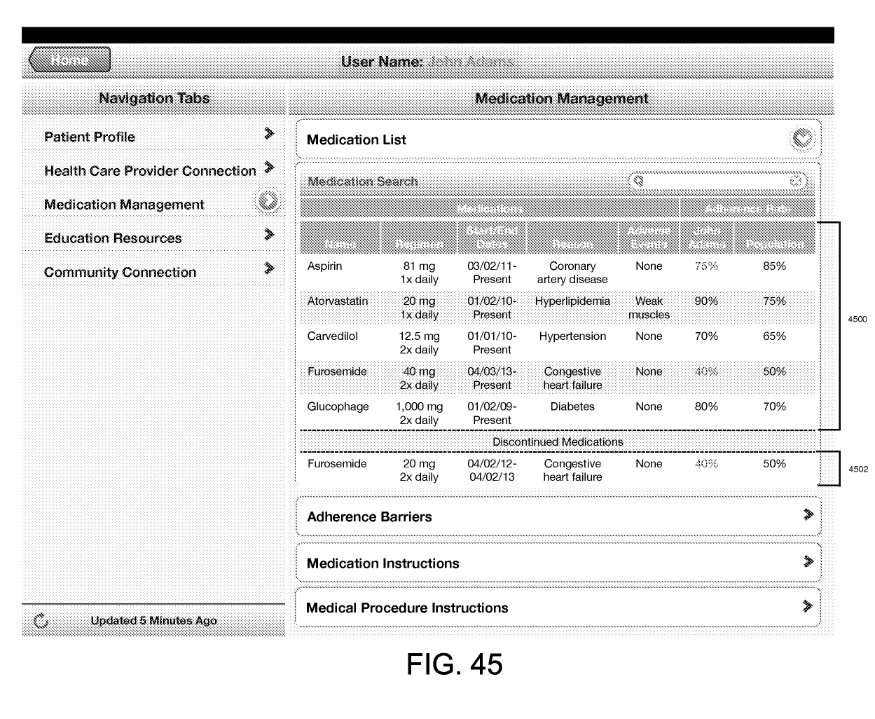

As illustrated in FIG. 44, the medication management screen includes a link to the medication list of the patient, a link to adherence barriers of the patient, a link to medication instructions for the patient, and a link to medical procedure instructions for the patient. In response to receiving input indicating selection of the medication list link, the patient interface provides a medication list screen as illustrated in FIG. 45.

As shown in FIG. 45, the medication list screen includes an active area 4500, an inactive area 4502, and a search box. The medication information displayed by the medication list screen includes medication name, regimen that includes medication dose and frequency, medication start and end dates, medication reason, any adverse events associated with the medication, patient adherence rate and adherence rate of a population (e.g., U.S. population). Other embodiments may display additional or alternative medication information and the embodiments disclosed herein are not limited to a particular set of medication information. In response to receiving input via the search box, the patient interface locates and highlights any medications matching the input.

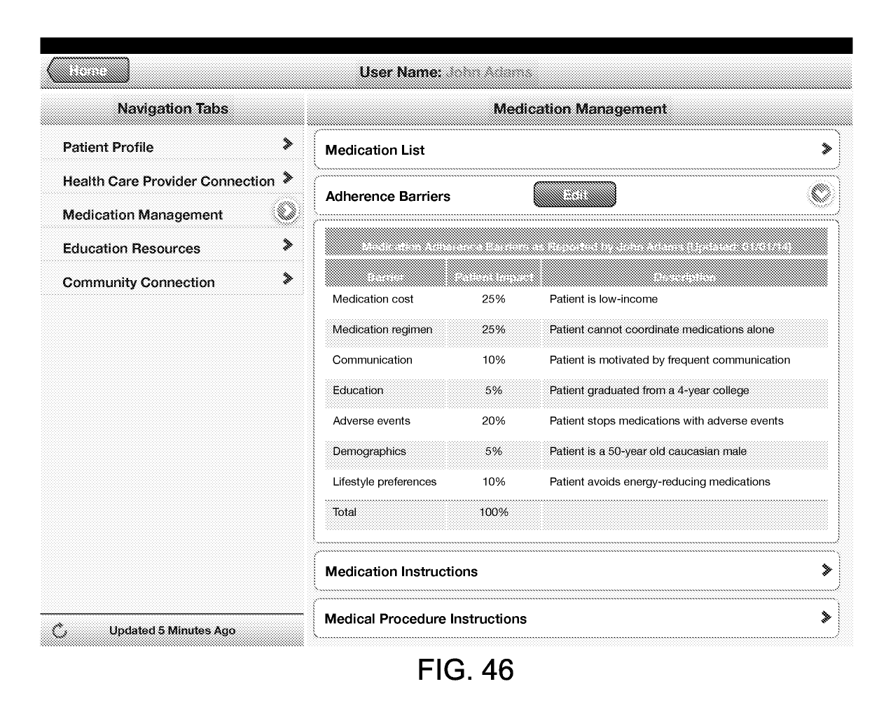

Returning to FIG. 44, in response to receiving input indicating selection of the adherence barriers link, the patient interface provides an adherence barriers screen as illustrated in FIG. 46.

As shown in FIG. 46, the adherence barriers screen includes an edit button and displays adherence barrier information associated with the patient. This adherence barrier information includes types of adherence barriers, a percentage impact of the adherence barrier type, and a description of the adherence barrier type. In response to receiving input indicating selection of the edit button, the patient interface enables the fields displaying the adherence barrier information to receive input. In response to receiving input within the fields displaying the adherence barrier information, the patient interface stores the adherence barrier information in the patient data store 122. In some embodiments, the patient interface may request confirmation prior to storing the adherence barrier information. Other embodiments may store and display additional or alternative adherence barrier information and the embodiments disclosed herein are not limited to a particular set of adherence barrier information.

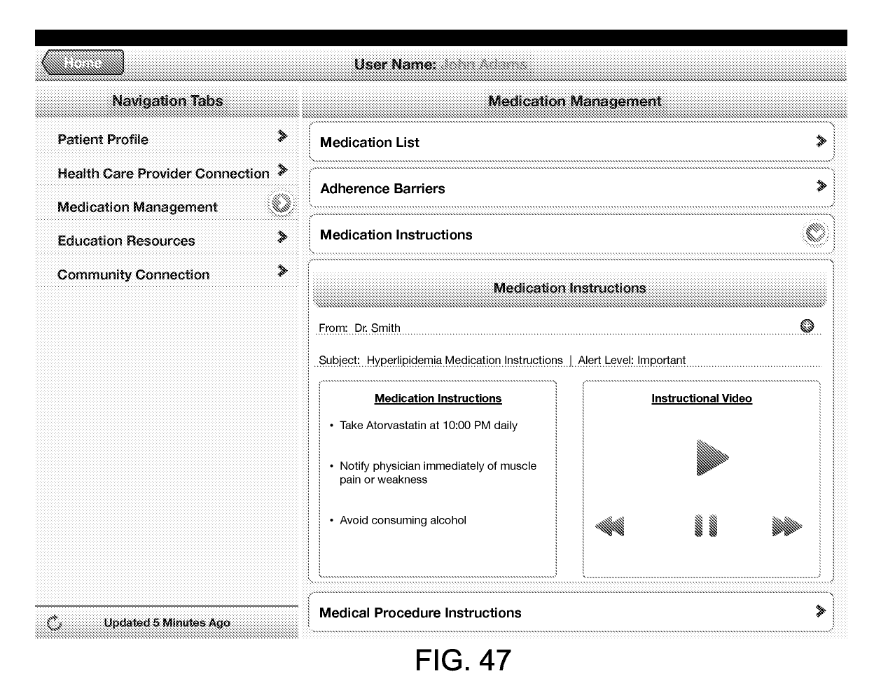

Returning to FIG. 44, in response to receiving input indicating selection of the medication instructions link, the patient interface provides a medication instructions screen as illustrated in FIG. 47.

As shown in FIG. 47, the medication instructions screen includes a message area. In an embodiment illustrated by FIG. 47, the patient interface is configured to display a message received from one or more health care providers in the message area. As shown in FIG. 47, the body of the message may include standardized (or customized) medication instructions and an instructional video.

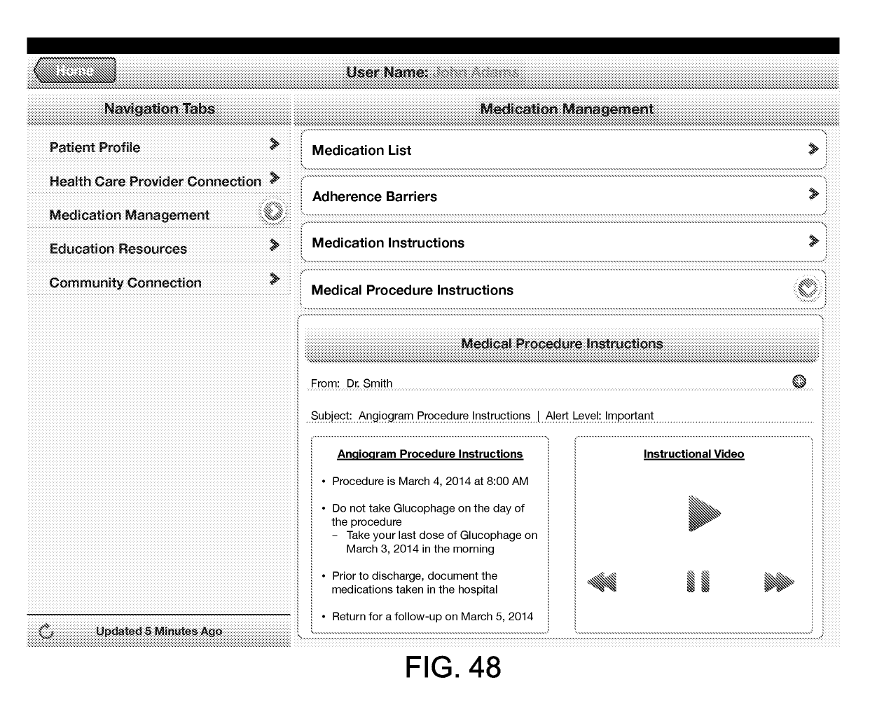

Returning to FIG. 44, in response to receiving input indicating selection of the medical procedure instructions link, the patient interface provides a medical procedure instructions screen as illustrated in FIG. 48.

As shown in FIG. 48, the medical procedure instructions screen includes a message area. In an embodiment illustrated by FIG. 48, the patient interface is configured to display a message received from one or more health care providers in the message area. As shown in FIG. 48, the body of the message may include standardized (or customized) medical procedure instructions and an instructional video.

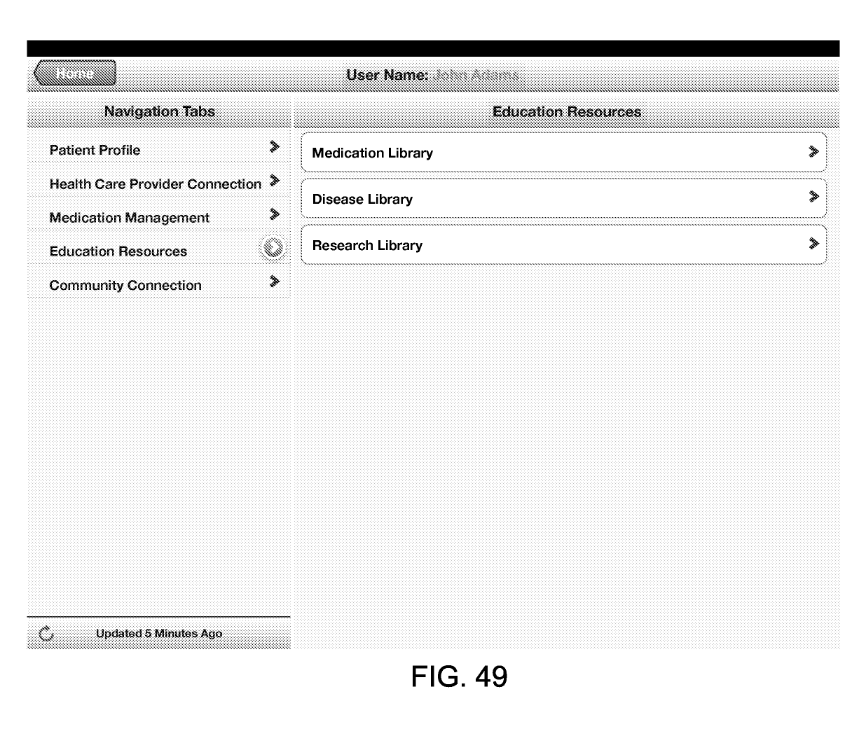

Returning to FIG. 35, in response to receiving input indicating selection of the education resources navigation tab, the patient interface displays an education resources screen as illustrated in FIG. 49.

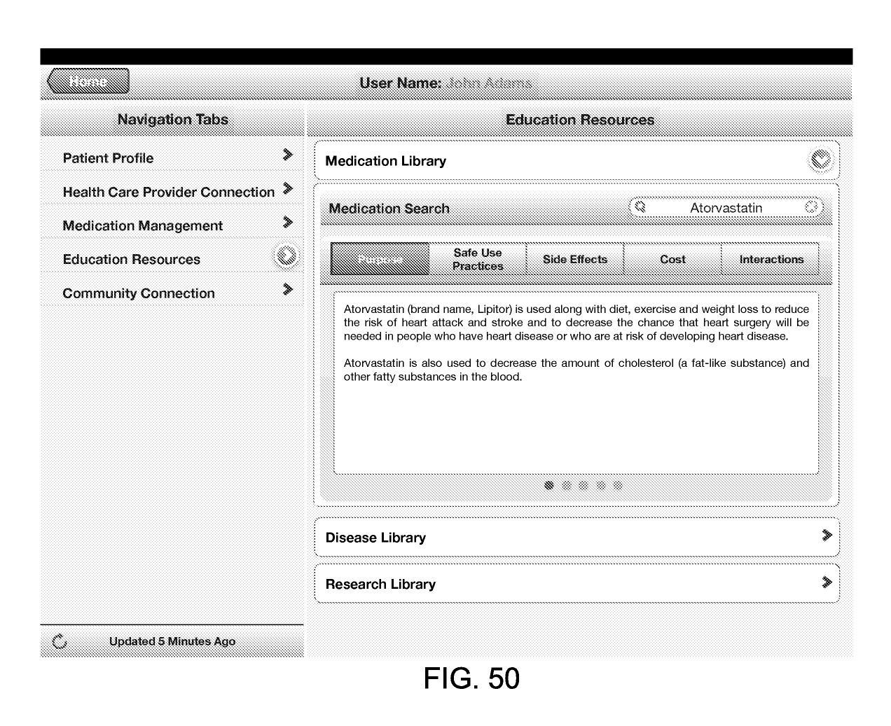

As shown in FIG. 49, the education resources screen includes a link to a medication library, a link to a disease library, and a link to a research library. In response to receiving input indicating selection of the medication library link, the patient interface provides a medication library screen as illustrated in FIG. 50.

As shown in FIG. 50, the medication library screen includes a search box. In response to receiving input via the search box, the patient interface locates and displays information for one or more medications matching the input. The medication information displayed by the medication library screen may include a variety of information of interest to the patient. As shown in FIG. 50, this medication information includes its purpose, safe use practices, side effects, cost, and interactions. Other embodiments may display additional or alternative medication information and the embodiments disclosed herein are not limited to a particular set of medication information.

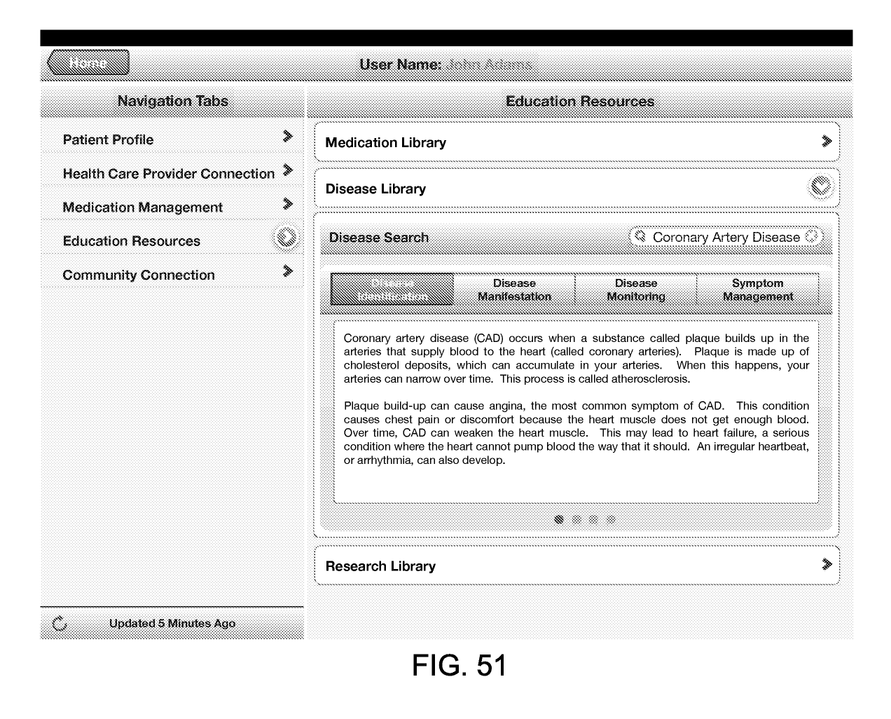

Returning to FIG. 49, in response to receiving input indicating selection of the disease library link, the patient interface provides a disease library screen as illustrated in FIG. 51.

As shown in FIG. 51, the disease library screen includes a search box. In response to receiving input via the search box, the patient interface locates and displays disease information matching the input. The disease information displayed by the disease library screen may include a variety of information of interest to the patient. As shown in FIG. 51, this disease topic information includes disease identification information, disease manifestation information, disease monitoring information, and symptom management information. Other embodiments may display additional or alternative disease information and the embodiments disclosed herein are not limited to a particular set of disease information.

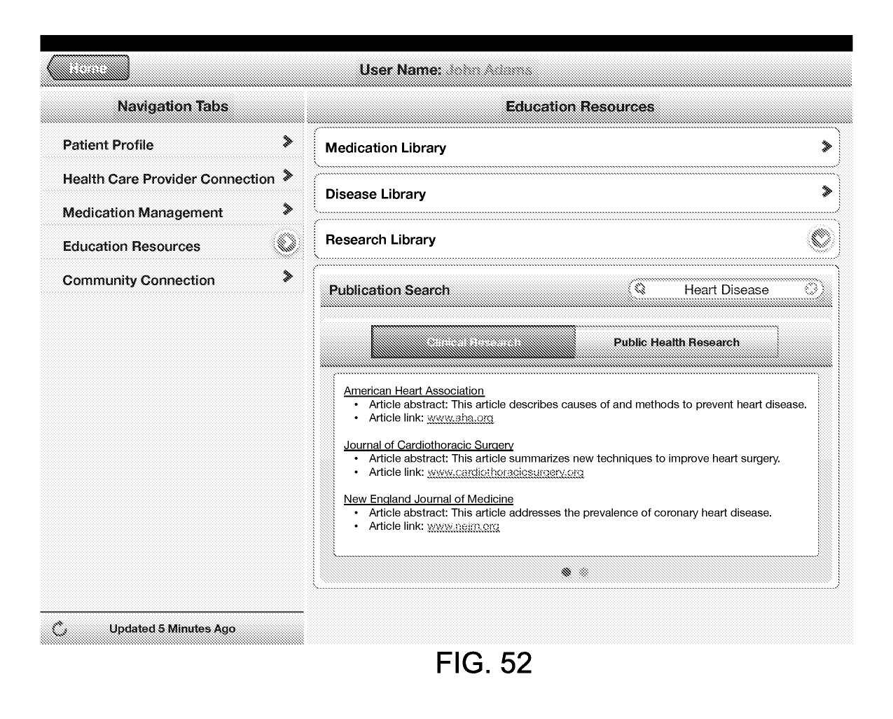

Returning to FIG. 49, in response to receiving input indicating selection of the research library link, the patient interface provides a research library screen as illustrated in FIG. 52.

As shown in FIG. 52, the research library screen includes a search box. In response to receiving input via the search box, the patient interface locates and displays information from one or more medical or public health publications matching the input. The research information displayed by the research library screen may include a variety of information of interest to the patient. As shown in FIG. 52, this research topic information includes clinical research and public health research. Other embodiments may display additional or alternative research topic information and the embodiments disclosed herein are not limited to a particular set of research topic information.

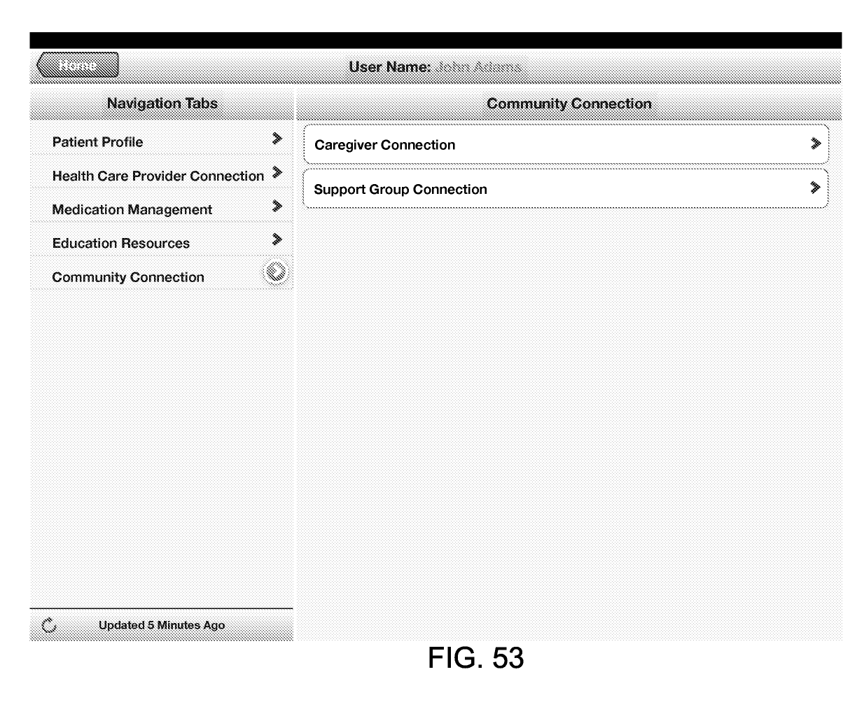

Returning to FIG. 35, in response to receiving input indicating selection of the community connection navigation tab, the patient interface displays a community connection screen as illustrated in FIG. 53.

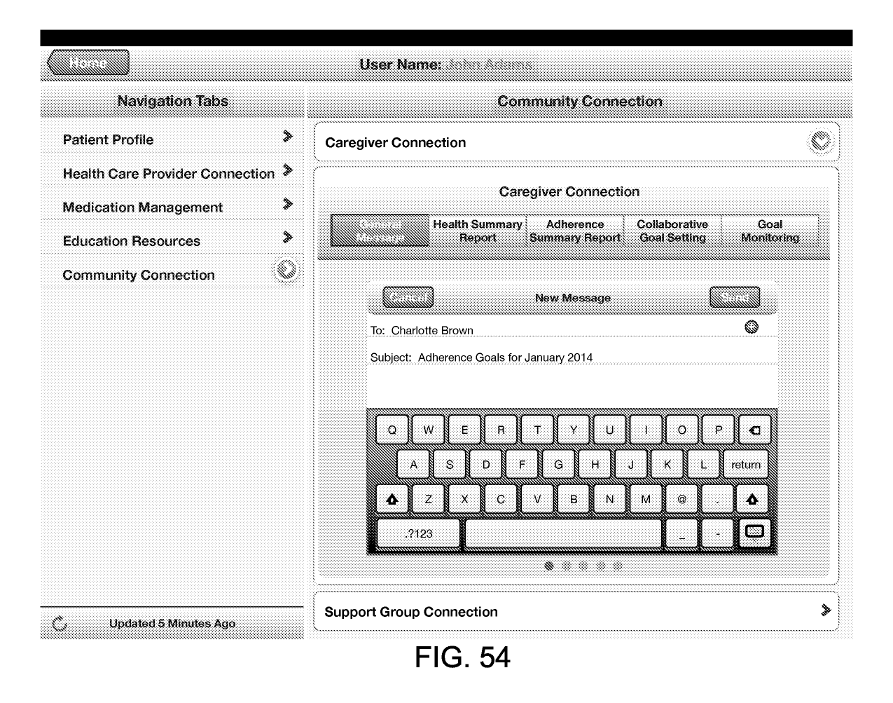

As shown in FIG. 53, the community connection screen includes a link to a caregiver connection and a link to a support group connection. In response to receiving input indicating selection of the caregiver connection link, the patient interface provides a caregiver connection screen as illustrated in FIG. 54.

As shown in FIG. 54, the caregiver connection screen includes a caregiver connection. The caregiver connection includes a set of topics, a message area, a send button, a cancel button, and a virtual keyboard.

In an embodiment illustrated by FIG. 54, the patient interface is configured to receive and process input via the message area indicating one or more caregivers to whom a message is addressed, input indicating the subject of the message, and a body of the message via the virtual keyboard. In response to receiving input indicating selection of one of the topics (e.g., general message, health summary report, adherence summary report, collaborative goal setting, or goal monitoring), the patient interface associates the selected topic with the message or generates a report that is associated with the selected topic from information previously processed by the analytics engine 124 and stored in the patient data store 122. In response to receiving input indicating selection of the send button, the patient interface is configured to send the message to one or more caregivers to whom the message is addressed. In response to receiving input indicating selection of the cancel button, the patient interface is configured to reset the message area. Other embodiments may display additional or alternative topics and the embodiments disclosed herein are not limited to a particular set of topics.

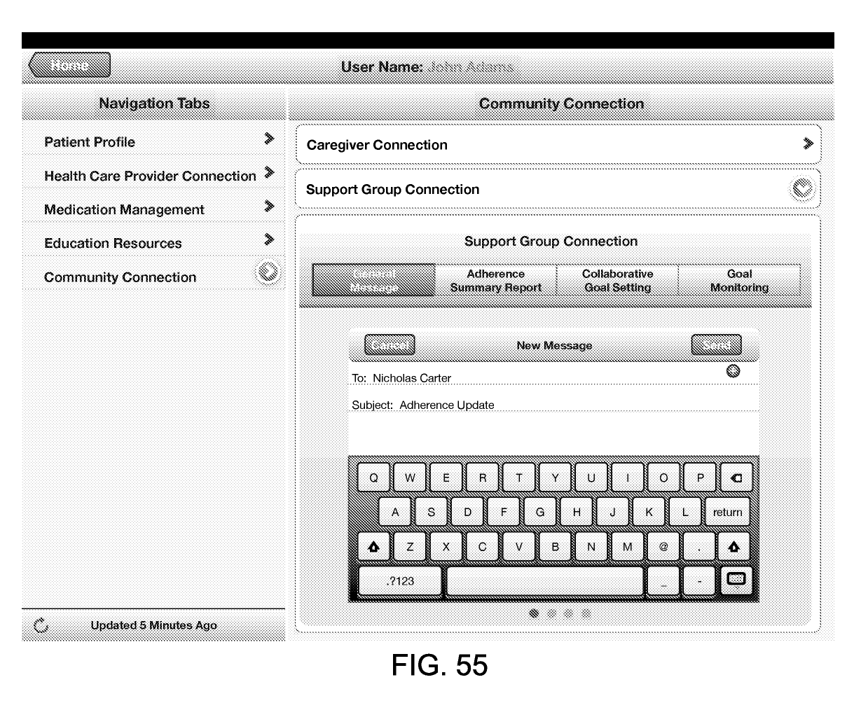

Returning to FIG. 53, in response to receiving input indicating selection of the support group connection link, the patient interface provides a support group connection screen as illustrated in FIG. 55.

As shown in FIG. 55, the support group connection screen includes a support group connection. The support group connection includes a set of topics, a message area, a send button, a cancel button, and a virtual keyboard.

In an embodiment illustrated by FIG. 55, the patient interface is configured to receive and process input via the message area indicating one or more support group members to whom a message is addressed, input indicating the subject of the message, and a body of the message via the virtual keyboard. In response to receiving input indicating selection of one of the topics (e.g., general message, adherence summary report, collaborative goal setting, or goal monitoring), the patient interface associates the selected topic with the message or generates a report that is associated with the selected topic from information previously processed by the analytics engine 124 and stored in the patient data store 122. In response to receiving input indicating selection of the send button, the patient interface is configured to send the message to one or more support group members to whom the message is addressed. In response to receiving input indicating selection of the cancel button, the patient interface is configured to reset the message area. Other embodiments may display additional or alternative topics and the embodiments disclosed herein are not limited to a particular set of topics.

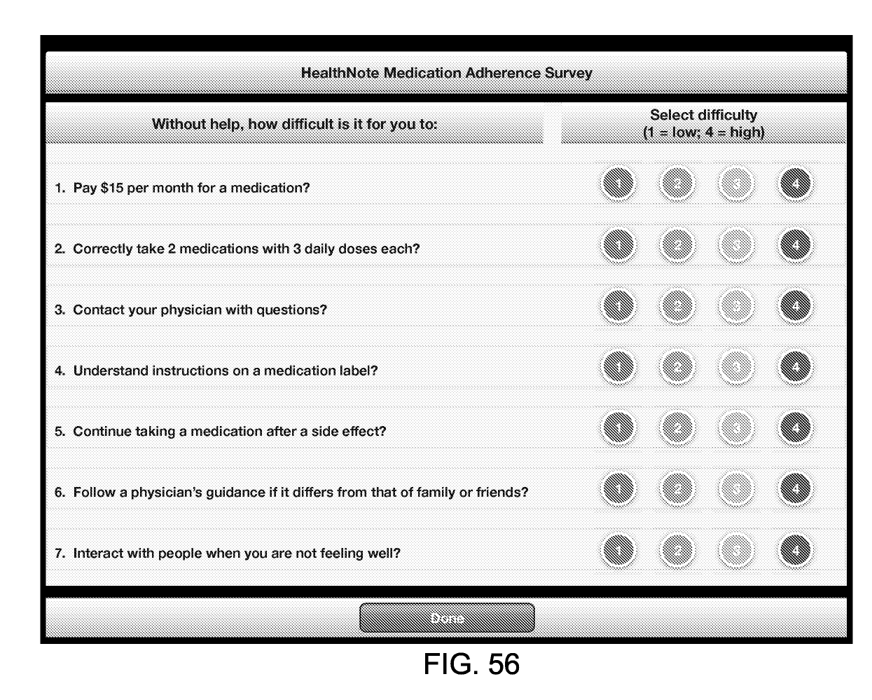

FIG. 56 illustrates a medication adherence survey screen provided by the patient interface. As shown in FIG. 56, the medication adherence survey screen includes user interface elements configured to receive input ranking the importance of each adherence barrier, represented by a series of questions, on a scale from 1 to 4. In response to receiving input indicating selection of a rank of each adherence barrier and selection of the done button, the patient interface stores the rank of each adherence barrier in the patient data store 122 in association with the patient operating the medication adherence survey screen. Other embodiments may display additional or alternative medication adherence survey information and the embodiments disclosed herein are not limited to a particular set of medication adherence survey information.

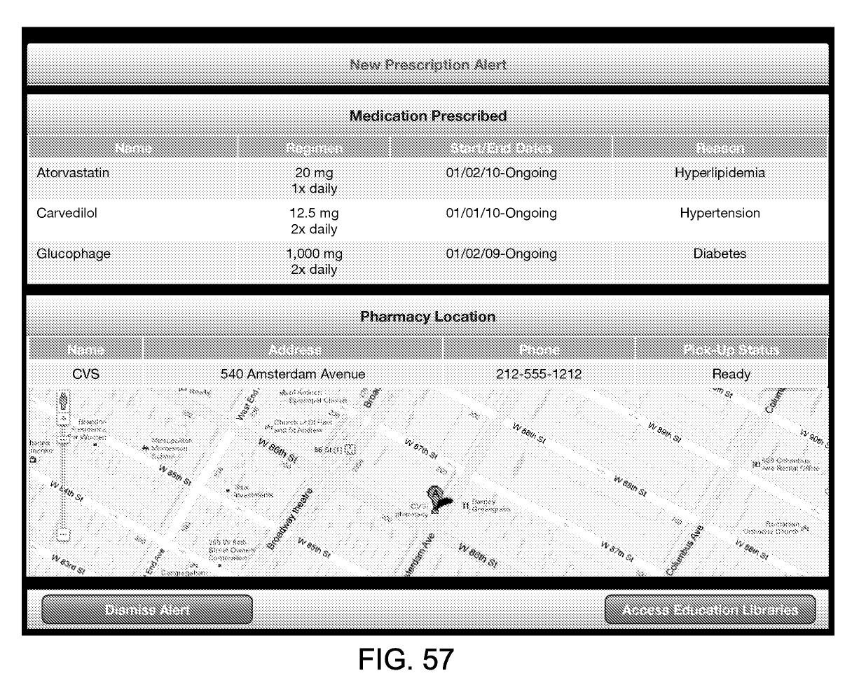

FIG. 57 illustrates a new prescription alert screen provided by the patient interface. As shown in FIG. 57, the new prescription alert screen displays a table of medications prescribed to the patient receiving the alert, the prescribed regimen of the medications including medication dose and frequency, start and end dates of the medications, reason for the medications, and location information for a pharmacy associated with the patient. In response to receiving input indicating selection of the dismiss alert button, the patient interface closes the alert screen. In response to receiving input indicating selection of the access education libraries button, the patient interface displays the education resources screen as illustrated in FIG. 49. Other embodiments may display additional or alternative new prescription alert-related information and the embodiments disclosed herein are not limited to a particular set of new prescription alert-related information.

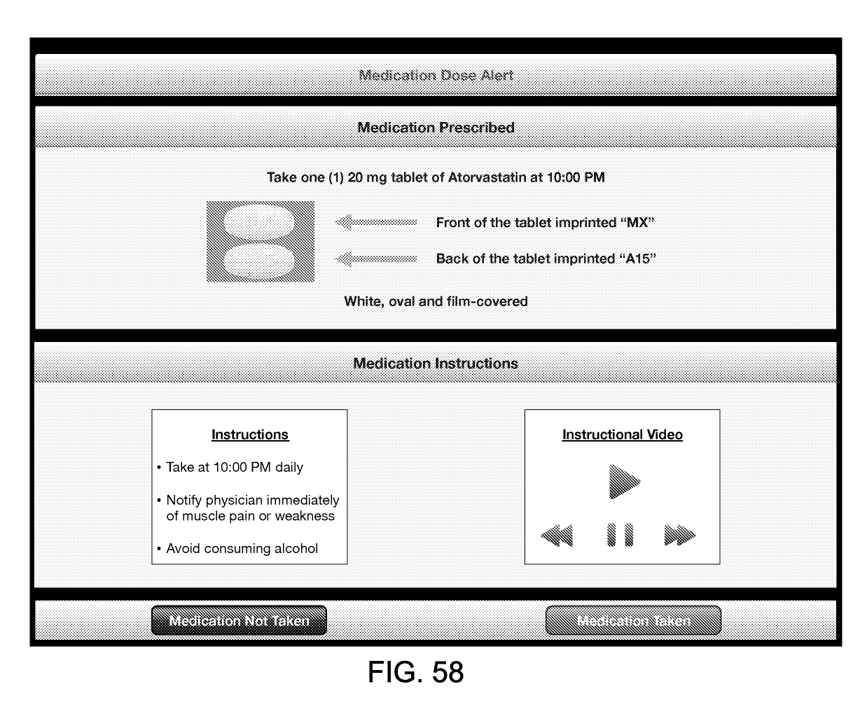

FIG. 58 illustrates a medication dose alert screen provided by the patient interface. As shown in FIG. 58, the medication dose alert screen displays a reminder notification to the patient to take a dose of prescribed medication at a time in accord with a medication regimen. The medication dose alert screen also displays medication instructions, an instructional video associated with the medication, a visual image of the medication and a written description of identifying features of the medication. In response to receiving input indicating selection of the medication taken button, the patient interface records the dose as taken in the patient data store 122. In response to receiving input indicating selection of the medication not taken button, the patient interface records the dose as not taken in the patient data store 122. Other embodiments may display additional or alternative medication dose alert-related information and the embodiments disclosed herein are not limited to a particular set of medication dose alert-related information.

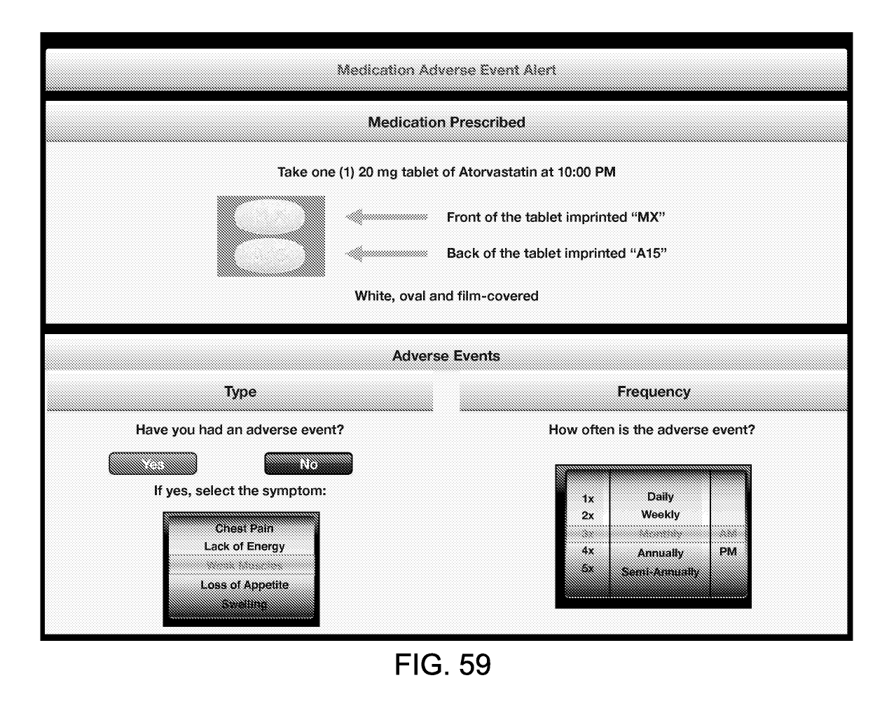

FIG. 59 illustrates a medication adverse event alert screen provided by the patient interface. As shown in FIG. 59, the medication adverse event alert screen displays a reminder notification to the patient to take a dose of prescribed medication at a time in accord with a medication regimen. The medication adverse event alert screen also displays a visual image of the medication and a written description of identifying features of the medication. Further, the medication adverse event alert screen includes an adverse event area through which the patient interface is configured to receive input descriptive of an adverse event. In response to receiving input indicating selection of the yes button, the patient interface records an adverse event associated with the dose of medication identified in the reminder notification and having the currently selected symptom and frequency within the patient data store 122. In response to receiving input indicating selection of the no button, the patient interface records no adverse event for the dose of medication identified in the reminder notification. Other embodiments may display additional or alternative medication adverse event alert-related information and the embodiments disclosed herein are not limited to a particular set of medication adverse event alert-related information.

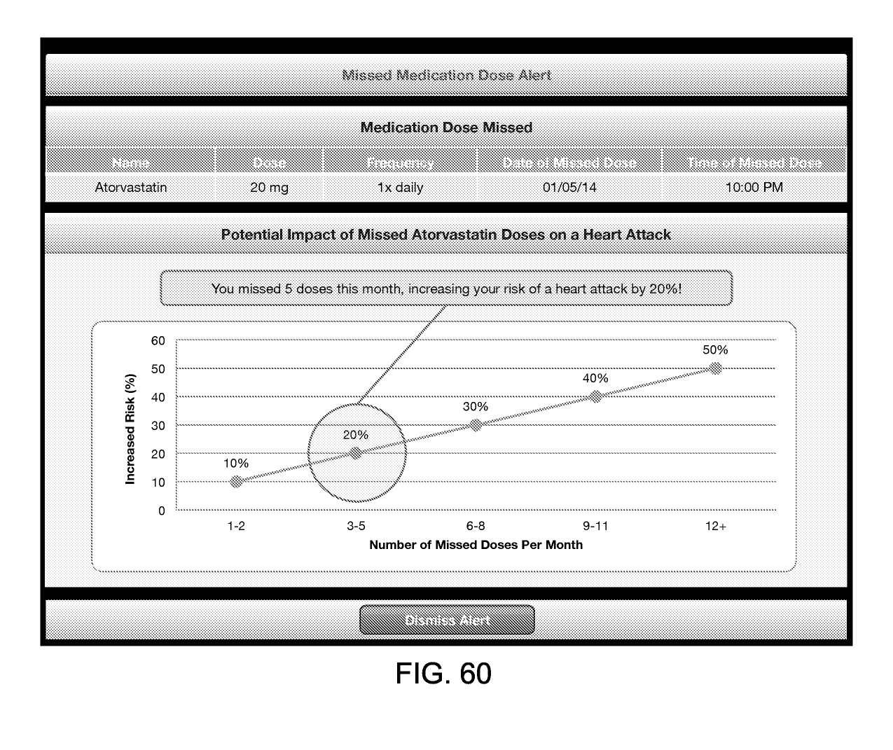

FIG. 60 illustrates a missed medication dose alert screen provided by the patient interface. As shown in FIG. 60, the missed medication dose alert screen displays a missed medication notification to the patient that identifies the name, dose, frequency, date, and time of a missed dose. The missed medication dose alert screen also displays educational information to the patient. As illustrated in FIG. 60, the missed medication dose alert screen displays a line graph indicating a potential impact of a missed medication dose on the risk of heart attack as a function of the number of missed doses of the medication. In response to receiving input indicating selection of the dismiss alert button, the patient interface records the selection of the dismiss alert button, dismisses the alert, and closes the screen. Other embodiments may display additional or alternative missed medication dose alert-related information and the embodiments disclosed herein are not limited to a particular set of missed medication dose alert-related information.

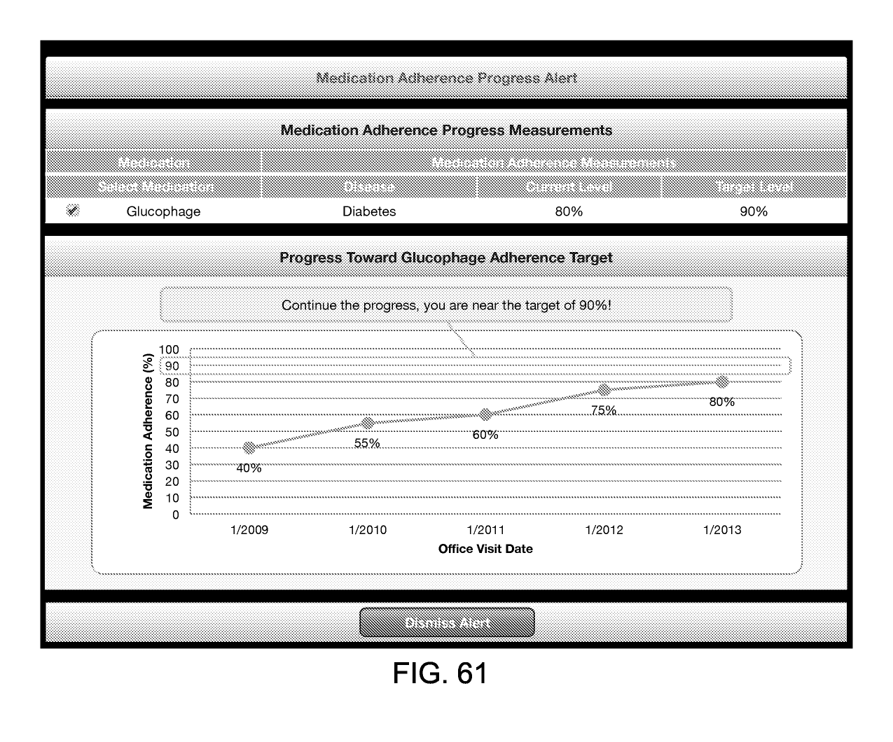

FIG. 61 illustrates a medication adherence progress alert screen provided by the patient interface. As shown in FIG. 61, the medication adherence progress alert screen displays medication adherence progress measurements to the patient. These measurements may include the name of a medication being taken by the patient and the disease that the medication is intended to treat. These measurements may also include medication adherence measurements such as the patient's current level of medication adherence to the selected medication and the patient's target level of medication adherence for the selected medication. The medication adherence progress alert screen also displays educational information to the patient. As illustrated in FIG. 61, the medication adherence progress alert screen displays a line graph indicating progress toward a medication adherence target over time. In response to receiving input indicating selection of the dismiss alert button, the patient interface records the selection of the dismiss alert button, dismisses the alert, and closes the screen. Other embodiments may display additional or alternative medication adherence progress alert-related information and the embodiments disclosed herein are not limited to a particular set of medication adherence progress alert-related information.

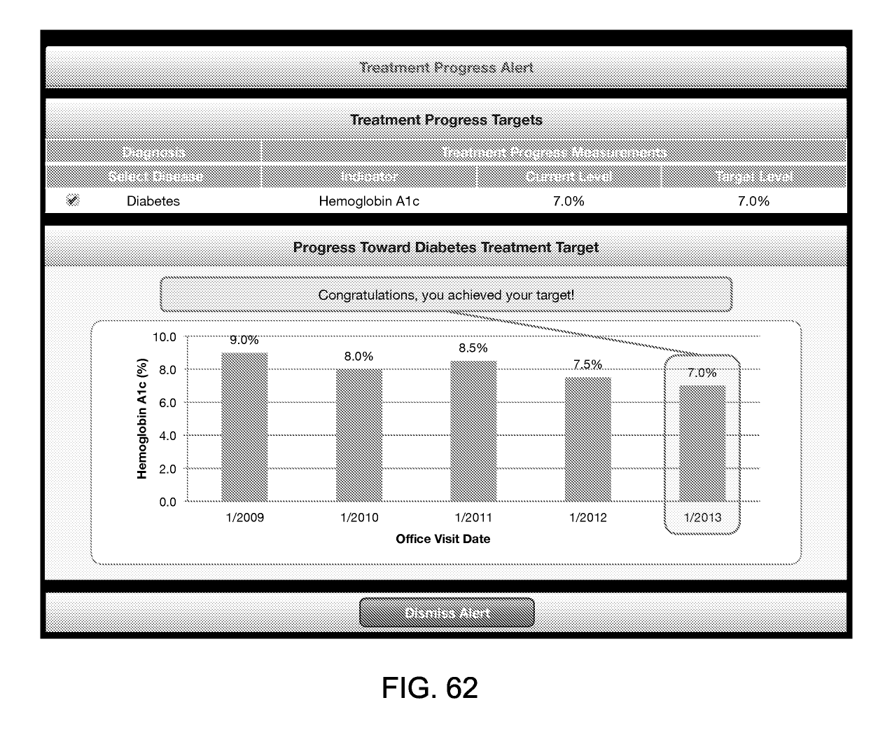

FIG. 62 illustrates a treatment progress alert screen provided by the patient interface. As shown in FIG. 62, the treatment progress alert screen displays diagnosis and treatment progress measurements information to the patient. The diagnosis and treatment progress measurements information displays previously diagnosed diseases, biological or non-biological indicators of treatment progress associated with a diagnosis, current levels of biological or non-biological indicators of treatment progress associated with a diagnosis, and target levels of biological or non-biological indicators of treatment progress associated with a diagnosis. The treatment progress alert screen also displays educational information to the patient. As illustrated in FIG. 62, the treatment progress alert screen displays a bar chart indicating progress toward a treatment target associated with the patient's disease as a function of the level of the biological or non-biological indicator over time. In response to receiving input indicating selection of the dismiss alert button, the patient interface records the selection of the dismiss alert button, dismisses the alert, and closes the screen. Other embodiments may display additional or alternative treatment progress alert-related information and the embodiments disclosed herein are not limited to a particular set of treatment progress alert-related information.

Various embodiments disclosed herein implement one or more third party interfaces, such as the third party interface 130 described above with reference to FIG. 1, through which a medication manager component, such as the medication manager component described above with reference to FIG. 1, receives and processes patient information requests. In some embodiments, the third party interface exchanges information with a third party, such as the third party 106 described above with reference to FIG. 1, via a computer system that is associated with the third party 106, such as the computer system 112 described above with reference to FIG. 1. These third party interfaces may incorporate one or more of the screens or information described above with reference to the health care provider interface and the patient interface, depending on the needs, rights and authorizations provided to the third party.

The interfaces disclosed herein exchange information with various providers and consumers. These providers and consumers may include any external entity including, among other entities, users and systems. Each of the interfaces disclosed herein may both restrict input to a predefined set of values and validate any information entered prior to using the information or providing the information to other components. Additionally, each of the interfaces disclosed herein may validate the identity of an external entity prior to, or during, interaction with the external entity. These functions may prevent the introduction of erroneous data into the medication manager component or unauthorized access to the medication manager component.

### Computer System

As discussed above with reference to FIG. 1, various aspects and functions described herein may be implemented as specialized hardware or software components executing in one or more computer systems. There are many examples of computer systems that are currently in use. These examples include, among others, network appliances, personal computers, workstations, mainframes, networked clients, servers, media servers, application servers, database servers, and web servers. Other examples of computer systems may include mobile computing devices, such as cellular phones and personal digital assistants, and network equipment, such as load balancers, routers, and switches. Further, aspects may be located on a single computer system or may be distributed among a plurality of computer systems connected to one or more communications networks.

For example, various aspects, functions, and processes may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, embodiments are not limited to executing on any particular system or group of systems. Further, aspects, functions, and processes may be implemented in software, hardware or firmware, or any combination thereof. Thus, aspects, functions, and processes may be implemented within methods, acts, systems, system elements and components using a variety of hardware and software configurations, and examples are not limited to any particular distributed architecture, network, or communication protocol.

Referring to FIG. 2, there is illustrated a block diagram of a distributed computer system 200, in which various aspects and functions are practiced. As shown, the distributed computer system 200 includes one or more computer systems that exchange information. More specifically, the distributed computer system 200 includes computer systems 202, 204, and 206. As shown, the computer systems 202, 204, and 206 are interconnected by, and may exchange data through, a communication network 208. The network 208 may include any communication network through which computer systems may exchange data. To exchange data using the network 208, the computer systems 202, 204, and 206 and the network 208 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST, and Web Services. To ensure data transfer is secure, the computer systems 202, 204, and 206 may transmit data via the network 208 using a variety of security measures including, for example, SSL or VPN technologies. While the distributed computer system 200 illustrates three networked computer systems, the distributed computer system 200 is not so limited and may include any number of computer systems and computing devices, networked using any medium and communication protocol.

As illustrated in FIG. 2, the computer system 202 includes a processor 210, a memory 212, an interconnection element 214, an interface 216 and data storage element 218. To implement at least some of the aspects, functions, and processes disclosed herein, the processor 210 performs a series of instructions that result in manipulated data. The processor 210 may be any type of processor, multiprocessor or controller. Example processors may include a commercially available processor such as an Intel Xeon, Itanium, Core, Celeron, or Pentium processor; an AMD Opteron processor; an Apple A4 or A5 processor; a Sun UltraSPARC processor; an IBM Power5+ processor; an IBM mainframe chip; or a quantum computer. The processor 210 is connected to other system components, including one or more memory devices 212, by the interconnection element 214.

The memory 212 stores programs (e.g., sequences of instructions coded to be executable by the processor 210) and data during operation of the computer system 202. Thus, the memory 212 may be a relatively high performance, volatile, random access memory such as a dynamic random access memory (“DRAM”) or static memory (“SRAM”). However, the memory 212 may include any device for storing data, such as a disk drive or other nonvolatile storage device. Various examples may organize the memory 212 into particularized and, in some cases, unique structures to perform the functions disclosed herein. These data structures may be sized and organized to store values for particular data and types of data.

Components of the computer system 202 are coupled by an interconnection element such as the interconnection element 214. The interconnection element 214 may include any communication coupling between system components such as one or more physical busses in conformance with specialized or standard computing bus technologies such as IDE, SCSI, PCI and InfiniBand. The interconnection element 214 enables communications, including instructions and data, to be exchanged between system components of the computer system 202.

The computer system 202 also includes one or more interface devices 216 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 202 to exchange information and to communicate with external entities, such as users and other systems.

The data storage element 218 includes a computer readable and writeable nonvolatile, or non-transitory, data storage medium in which instructions are stored that define a program or other object that is executed by the processor 210. The data storage element 218 also may include information that is recorded, on or in, the medium, and that is processed by the processor 210 during execution of the program. More specifically, the information may be stored in one or more data structures specifically configured to conserve storage space or increase data exchange performance. The instructions may be persistently stored as encoded signals, and the instructions may cause the processor 210 to perform any of the functions described herein. The medium may, for example, be optical disk, magnetic disk or flash memory, among others. In operation, the processor 210 or some other controller causes data to be read from the nonvolatile recording medium into another memory, such as the memory 212, that allows for faster access to the information by the processor 210 than does the storage medium included in the data storage element 218. The memory may be located in the data storage element 218 or in the memory 212, however, the processor 210 manipulates the data within the memory, and then copies the data to the storage medium associated with the data storage element 218 after processing is completed. A variety of components may manage data movement between the storage medium and other memory elements and examples are not limited to particular data management components. Further, examples are not limited to a particular memory system or data storage system.

Although the computer system 202 is shown by way of example as one type of computer system upon which various aspects and functions may be practiced, aspects and functions are not limited to being implemented on the computer system 202 as shown in FIG. 2. Various aspects and functions may be practiced on one or more computers having different architectures or components than those shown in FIG. 2. For instance, the computer system 202 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 202 may be a computer system including an operating system that manages at least a portion of the hardware elements included in the computer system 202. In some examples, a processor or controller, such as the processor 210, executes an operating system. Examples of a particular operating system that may be executed include a Windows-based operating system, such as, Windows NT, Windows 2000 (Windows ME), Windows XP, Windows Vista or Windows 7 operating systems, available from the Microsoft Corporation, a MAC OS System X operating system or an iOS operating system available from Apple Computer, one of many Linux-based operating system distributions, for example, the Enterprise Linux operating system available from Red Hat Inc., a Solaris operating system available from Oracle Corporation, or a UNIX operating systems available from various sources. Many other operating systems may be used, and examples are not limited to any particular operating system.

The processor 210 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, C# (C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

### Medication Management Processes

As described above with reference to FIG. 1, several embodiments perform processes that execute medication management processes. In some embodiments, these medication management processes are executed by a medication management system, such as the medication management system 100 described above with reference to FIG. 1. One example of such a medication management process is illustrated in FIG. 63. According to this example, the medication management process 6300 includes several acts which are described below.

In act 6302, a health care provider interface, such as the health care provider interface 128 described above with reference to FIG. 1, processes a patient information request from an external entity, such as the health care provider 104 described above with reference to FIG. 1. According to one example, the patient information request includes a request to create a new patient account initiated by selection of the create patient account button described above with reference to FIG. 5.

In act 6304, the medication management system determines whether a patient has accepted the account creation request. For example, the medication management system may determine whether the patient for whom the account was requested has logged into the medication management system via, a patient interface, such as the patient interface 126 described above with referenced to FIG. 1.

If the medication management system determines that the patient has accepted the account creation request, the medication management system optionally executes act 6306. Otherwise the medication management system terminates the medication management process.

In the act 6306, the medication management system optionally deploys a client to a computer associated with the patient, such as the computer system 108 described above with reference to FIG. 1.

In act 6308, the medication management system receives a patient information request from the health care provider including prescription information to store in a patient data store, such as the patient data store 122 described above with reference to FIG. 1.

In act 6310, the medication management system transmits a reminder notification to the patient to take a dose according to the prescribed medication regimen.

In act 6312, the medication management system receives input indicating whether or not the patient adhered to the prescribed medication regimen by taking the dose.

In act 6314, the medication management system receives and processes a variety of patient information requests that are described above with reference to FIGS. 3-62.

Processes in accord with the medication management process 6300 monitor, record, and reinforce adherence to prescribed (and non-prescribed) medication regimens, and improve the accuracy, availability, and utility of medication effectiveness and use data, thereby improving the health of patients, productivity of health care providers, and decreasing the overall costs of individuals and organizations across the health care system.

Process 6300 illustrates one particular sequence of acts in a particular embodiment. The acts included in this process may be performed by, or using, one or more computer systems specially configured as discussed herein. Some acts are optional and, as such, may be omitted in accord with one or more embodiments. Additionally, the order of acts can be altered, or other acts can be added, without departing from the scope of the embodiments described herein. Furthermore, as described above, in at least one embodiment, the acts are performed on particular, specially configured machines, namely components of the medication management system configured according to the examples and embodiments disclosed herein.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. A computer system comprising:
a memory;
at least one processor coupled to the memory; and
a medication management component executable by the at least one processor and configured to:
transmit a first notification to a first remote computer system, the first notification including a first request that the first remote computer system present a reminder to a patient, the reminder requesting that the patient adhere to a medication regimen;
receive a response to the notification, the response indicating whether the patient adhered to the medication regimen; and
transmit a second notification to a second remote computer system distinct from the first remote computer system, the second notification including a second request that the second remote computer system present an indication of whether the patient adhered to the medication regimen to a health care provider.
